(19) United States
(12) Patent Application Publication
(10) Pub. No.: US 2017/0210554 A1
(43) Pub. Date: Jul. 27, 2017

(54) NUTRITIONAL POWDER PODS CONTAINING NUTRITIONAL POWDERS WITH VOLUME FLOWABILITY PROPERTIES

(71) Applicant: ABBOTT LABORATORIES, Abbott Park, IL (US)

(72) Inventors: CYNTHIA BLACK, Westerville, OH (US); YOUNGSUK HEO, Powell, OH (US); TIMOTHY LAPLANTE, Powell, OH (US); PETER WESTFALL, Westerville, OH (US); GARY KATZ, Columbus, OH (US); CATHERINE LAMB, Westerville, OH (US); MARK ENGLE, Plain City, OH (US); NAGENDRA RANGAVAJLA, Dublin, OH (US)

(73) Assignee: ABBOTT LABORATORIES, Abbott Park, IL (US)

(21) Appl. No.: 15/328,209

(22) PCT Filed: Jul. 21, 2015
(86) PCT No.: PCT/US2015/041289

§ 371 Date: Jan. 23, 2017

Related U.S. Application Data
(60) Provisional application No. 62/026,885, filed on Jul. 21, 2014.
(60) Provisional application No. 62/026,928, filed on Jul. 21, 2014.

(51) Int. Cl. B65D 85/804; A23P 10/40; A23L 33/00

(52) U.S. Cl. CPC B65D 85/8046; A23L 33/40; A23P 10/40; A23V 2002/00

(57) ABSTRACT

Disclosed herein are nutritional powder pods, and their methods of making and using with beverage production machine. Certain aspects of disclosure include nutritional powders with certain properties (e.g., volume flowability, reconstitution time, reconstitution yield, mean particle size, rate of reconstitution, moisture content, surface area, non-circularity (<0.95), circularity, and convexity) that can make the nutritional powder particularly suitable for use in a beverage production machine.

### CROSS-REFERENCE TO RELATED APPLICATIONS

This application claims the benefit of U.S. Provisional Application Nos. 62/026,928, filed Jul. 21, 2014, which is herein incorporated by reference in its entirety, and 62/026,885, filed Jul. 21, 2014, which is herein incorporated by reference in its entirety.

### FIELD

Disclosed herein are nutritional powder pods, and related methods for preparing and using them.

### BACKGROUND

Beverage production machines are available that automate the process of making tea or coffee, where, in some instances, the tea or coffee resides in a pod into which water is added by the machine. In some designs, the pod acts as a type of filter to prevent the tea leaves or coffee grinds from entering the beverage container, while the liquid tea or liquid coffee flows from the pod to the beverage container. The hot beverage is then consumed.

There currently exist pre-packaged nutritional compositions that are sold in canisters, foil packages, paper packages, or multipacks. Infant formulas and adult supplementary formulas are available in powder or liquid formulations. When in powder form, the liquid composition is generally prepared by shaking or stirring the powder by hand, before it is consumed.

### SUMMARY

Embodiments of the present disclosure include nutritional powder pods for use with a beverage production machine, the nutritional powder pods containing a nutritional powder. In certain embodiments, the nutritional powder has a volume flowability index of from about 1 to about 2 and a reconstitution time of no more than 60 seconds. In other embodiments, the nutritional powder has a volume flowability index of from about 1, about 1.1, about 1.2, about 1.3, about 1.4, about 1.5, or from about 1 to about 1.5. In still other embodiments, the nutritional powder has a reconstitution time of no more than 50 seconds.

In some embodiments, the nutritional powder has a reconstitution yield of at least about 75% or from about 80% to about 100%. In other embodiments, the nutritional powder particles have a mean particle size of from about 40 μm to about 500 μm or from about 80 μm to about 400 μm.

In yet other embodiment, the nutritional powder has a rate of reconstitution of no more than about 25 mg/g-sec, no more than about 10 mg/g-sec, from about 0.1 mg/g-sec to about 25 mg/g-sec, from about 0.1 mg/g-sec to about 10 mg/g-sec, or from about 1 mg/g-sec to about 9 mg/g-sec. In certain embodiments, the nutritional powder has a moisture content of no more than about 6%, from about 0.1% to about 6%, or from about 1% to about 5%.

In some embodiments, the nutritional powder particles have a surface area of from 0.01 m²/g to about 0.5 m²/g or from 0.02 m²/g to about 0.2 m²/g. In other embodiments, the nutritional powder particles have a non-circularity (<0.95) of from about 20% to about 90% or from about 25% to about 80%. With other embodiments, the nutritional powder particles have a circularity of from about 0.85 to about 0.99 or from about 0.88 to about 0.95. In some embodiments, the nutritional powder particles have a convexity of from about 0.9 to about 0.995 or from about 0.94 to about 0.99.

Other embodiments disclosed herein include methods for preparing a liquid product using a nutritional powder pod, comprising mixing a liquid, such as water, with the nutritional powder of the nutritional powder pod. The nutritional powder can, for example, have a volume flowability index of from about 1 to about 2 and a reconstitution time of no more than 60 seconds. In certain aspects of the disclosure, at least about 75 weight % of the nutritional powder is mixed with the liquid.

Further embodiments include methods for preparing a liquid product using a nutritional powder pod, the method comprising mixing a liquid, such as water, with nutritional powder from the nutritional powder pod, thereby creating a liquid product. The nutritional powder can, for example, have a volume flowability index of from about 1 to about 2 and a reconstitution time of no more than 60 seconds. In certain aspects of the disclosure, the liquid product comprises at least about 75 weight % of the nutritional powder is mixed in the liquid product.

Additional embodiments of the disclosure include methods for preparing a nutritional powder pod for use in a beverage production machine, the method comprising enclosing a nutritional powder in a pod, thereby resulting in the nutritional powder pod. The nutritional powder can, for example, have a volume flowability index of from about 1 to about 2 and a reconstitution time of no more than 60 seconds.

Further embodiments of the disclosure include methods for preparing a nutritional powder pod for use in a beverage production machine, the method comprising extruding a nutritional composition, drying the extruded nutritional composition to form a nutritional powder, and enclosing the nutritional powder in a pod, resulting in the nutritional powder pod. The nutritional powder can, for example, have a volume flowability index of from about 1 to about 2 and a reconstitution time of no more than 60 seconds.

Also disclosed herein is a nutritional powder pod produced by the method for preparing a nutritional powder as disclosed herein.

Further disclosed herein is a package comprising a plurality of nutritional powder pods as disclosed herein. Additional embodiments include a package comprising a beverage production machine and at least one nutritional powder pod as disclosed herein.

### BRIEF DESCRIPTION OF THE DRAWINGS

FIG. 1 illustrates the bottom and top sections of a bulk density test cylinder.

FIG. 2 illustrates a modified vibration tester used for the vibrated bulk density test method.

FIG. 3 shows the reconstitution rate as a function of reconstitution time averaged for available data of examples 4-38.

### DETAILED DESCRIPTION

While embodiments encompassing the general inventive concepts may take diverse forms, various embodiments will be described herein, with the understanding that the present disclosure is to be considered merely exemplary, and the general inventive concepts are not intended to be limited to the disclosed embodiments.

Certain embodiments of this invention include a pod which comprises nutritional powder and which is suitable for use in a beverage production machine. Without being bound by theory, in certain aspects of the disclosure, certain properties (e.g., one or more of volume flowability, moisture content, rate of reconstitution, particle size, particle size distribution, particle shape, or particle shape distribution) of the nutritional powder may enhance the suitability of nutritional powder when used in a beverage production machine. In certain instances, the nutritional composition can further comprise one or more of a fat, a protein, or a carbohydrate.

### Definitions

The terms “adult formula” and “adult nutritional product” as used herein, unless otherwise specified, are used interchangeably to refer to nutritional compositions suitable for generally maintaining or improving the health of an adult.

The term “agglomerated” as used herein, unless otherwise specified, refers to a nutritional powder that is processed such that individual powder particles are fused together to form porous aggregates of powder particles. The agglomerated nutritional powders described herein may be produced according to well known processes including, but not limited to, rewetting agglomeration, fluid-bed agglomeration, pressure agglomeration, and instantization by spray lecithination.

The term “bulk density” as used herein, unless otherwise specified, refers to the density of powder or other finely-divided solid without excluding the open space. Bulk density is calculated by dividing the mass of a given portion of a powder by the total powder volume.

The term “infant,” as used herein, unless otherwise specified, refers to a human about 36 months of age or younger. The term “toddler,” as used herein, unless otherwise specified, refers to a subgroup of infants from about 12 months of age to about 36 months (3 years) of age. The term “child,” as used herein, unless otherwise specified, refers to a human about 3 years of age to about 18 years of age. The term “adult,” as used herein, unless otherwise specified, refers to a human about 18 years of age or older.

The terms “infant formula” or “infant nutritional product” as used herein, unless otherwise specified, are used interchangeably to refer to nutritional compositions that have the proper balance of macronutrients, micro-nutrients, and calories to provide sole or supplemental nourishment for and generally maintain or improve the health of infants, toddlers, or both. Infant formulas preferably comprise nutrients in accordance with the relevant infant formula guidelines for the targeted consumer or user population, an example of which would be the Infant Formula Act, 21 U.S.C. Section 350(a).

The term “initiation time” as used herein, unless otherwise specified, refers to the time at which any liquid from a beverage production machine first makes contact with or otherwise impinges upon the contents of a pod.

The term “liquid product” as used herein, unless otherwise specified, refers to the reconstituted nutritional powder.

The term “loose bulk density” as used herein, unless otherwise specified, refers to the density (grams per unit volume) of nutritional powder that has not been tapped, packed, compressed, vibrated, or otherwise allowed to settle. It should be understood that for purposes of measuring loose bulk density on a given portion of a nutritional powder, a powder that has been tapped, packed, compressed, vibrated, or otherwise allowed to settle, can be re-distributed according to analytical methods such that loose bulk density can be measured.

The term “majority” as used herein, unless otherwise specified, means more than about 50%, including at least about 60%, at least about 65%, at least about 70%, at least about 75%, at least about 80%, at least about 85%, at least about 90%, at least about 95%, at least about 99%, and up to and including about 100%.

The term “nutritional composition” as used herein, unless otherwise specified, refers to nutritional powders and concentrated liquids. The nutritional powders may be reconstituted to form nutritional liquids suitable for oral consumption by a human. The concentrated liquids may be diluted or otherwise augmented to form nutritional liquids suitable for oral consumption by a human.

The terms “particle” or “particles” as used herein, unless otherwise specified, refer to finely-divided pieces of solid material which make up a powder. It should be understood that “particles” includes both individual particles and agglomerated particles. When only individual particles are meant, the term “individual particle(s)” is used. When only agglomerated particles are meant, the term “agglomerated particle(s)” is used.

The terms “pediatric formula” or “pediatric nutritional product,” as used herein, unless otherwise specified, are used interchangeably to refer to nutritional compositions suitable for generally maintaining or improving the health of toddlers, children, or both.

The term “pod” as used herein, unless otherwise specified, refers to a sealable, re-sealable, or sealed container having an internal volume capable of containing a solid, powder, or liquid formulation that, when mixed with a liquid, yields a liquid product suitable for human consumption.

The term “reconstitute” as used herein, unless otherwise specified, refers to a process by which the nutritional powder is mixed with a liquid, typically water, to form an essentially homogeneous liquid product. Once reconstituted in the liquid, the ingredients of the nutritional powder may be any combination of dissolved, dispersed, suspended, colloidally suspended, emulsified, or otherwise blended within the liquid matrix of the liquid product. Therefore, the resulting reconstituted liquid product may be characterized as any combination of a solution, a dispersion, a suspension, a colloidal suspension, an emulsion, or a homogeneous blend.

The term “serving” as used herein, unless otherwise specified, is any amount of a composition that is intended to be ingested by a subject in one sitting or within less than about one hour. The size of a serving (i.e., “serving size”) may be different for diverse individuals, depending on one or more factors including, but not limited to, age, body mass, gender, species, or health. For a typical human child or adult, a serving size of the compositions disclosed herein is from about 25 mL to about 1 L. For a typical human infant or toddler, a serving size of the compositions disclosed herein is from about 5 mL to about 250 mL.

The term “vibrated bulk density” as used herein, unless otherwise specified, refers to the density (grams per unit volume) of powder that has been compressed using the Vibrated Bulk Density Test method, described below.

Generally, certain embodiments of the present disclosure relate to nutritional powder pods for use with a beverage production machine; the nutritional powder pods comprise a nutritional powder.

Without being bound by theory, it is believed that in certain embodiments the specified range of volume flowability of the nutritional powder is particularly suited for a nutritional powder pod environment. In other embodiments, without being bound by theory, it is believed that the specified range of reconstitution time of the nutritional powder is particularly suited for a nutritional powder pod environment. In other embodiments, without being bound by theory, it is believed that the specified range of reconstitution yield of the nutritional powder is particularly suited for a nutritional powder pod environment. In other embodiments, without being bound by theory, it is believed that the specified range of moisture content of the nutritional powder is particularly suited for a nutritional powder pod environment. In other embodiments, without being bound by theory, it is believed that the specified range of mean particle size of the nutritional powder is particularly suited for a nutritional powder pod environment. In other embodiments, without being bound by theory, it is believed that the specified range of particle surface area of the nutritional powder is particularly suited for a nutritional powder pod environment. In other embodiments, without being bound by theory, it is believed that the specified range of the percent of particles that have certain 2-D particle shapes (e.g., one or more of non-circularity, circularity, convexity) is particularly suited for a nutritional powder pod environment. In other embodiments, without being bound by theory, it is believed that the specified combination of ranges for the volume flowability and the reconstitution time together are particularly suited for a nutritional powder pod environment. In other embodiments, without being bound by theory, it is believed that the specified combination of ranges for the mean surface area and the reconstitution time together are particularly suited for a nutritional powder pod environment. In yet other embodiments, without being bound by theory, it is believed that the specified combination of ranges for the volume flowability and the moisture content together are particularly suited for a nutritional powder pod environment. In yet other embodiments, without being bound by theory, it is believed that the specified combination of ranges for the volume flowability and the mean particle size together are particularly suited for a nutritional powder pod environment. In still other embodiments, without being bound by theory, it is believed that the specified combination of ranges for the moisture content and the reconstitution time together are particularly suited for a nutritional powder pod environment. In other embodiments, without being bound by theory, it is believed that the specified combination of ranges for the volume flowability, moisture content, and the reconstitution time together are particularly suited for a nutritional powder pod environment. In other embodiments, without being bound by theory, it is believed that the specified combination of ranges for the volume flowability, mean particle size, and the reconstitution time together are particularly suited for a nutritional powder pod environment. In other embodiments, without being bound by theory, it is believed that the specified combination of ranges for the volume flowability, the moisture content, the mean particle size, the percent of particles with certain 2-D particle shapes (e.g., one or more of non-circularity, circularity, convexity), and the reconstitution yield together are particularly suited for a nutritional powder pod environment.

As discussed above, in certain embodiments, the nutritional powder has a specified volume flowability, including a volume flowability in units of flowability index of about 1, about 1.05, about 1.1, about 1.15, about 1.2, about 1.25, about 1.3, about 1.35, about 1.4, about 1.45, about 1.5, about 1.6, about 1.7, about 1.8, about 1.9, about 2, from about 1 to about 2, from about 1 to about 1.5, from about 1.05 to about 1.5, from about 1.05 to about 1.45, from about 1.05 to about 1.4, from about 1.05 to about 1.35, from about 1.05 to about 1.3, from about 1.1 to about 1.45, from about 1.1 to about 1.4, from about 1.1 to about 1.35, from about 1.1 to about 1.3, from about 1.15 to about 1.45, from about 1.15 to about 1.4, from about 1.15 to about 1.35, from about 1.15 to about 1.3, from about 1.2 to about 1.45, from about 1.2 to about 1.4, from about 1.2 to about 1.35, from about 1.2 to about 1.3, from about 1.25 to about 1.45, from about 1.25 to about 1.4, from about 1.25 to about 1.35, or from about 1.25 to about 1.3. Volume flowability in units of flowability index can be determined using any suitable method, including the method found in Example Set 1.

In certain embodiments, the nutritional powder has a loose bulk density of about 0.2 g/cc, about 0.3 g/cc, about 0.4 g/cc, about 0.5 g/cc, about 0.6 g/cc, about 0.7 g/cc, about 0.8 g/cc, about 0.9 g/cc, about 1 g/cc, from about 0.2 g/cc to about 1 g/cc, from about 0.3 g/cc to about 0.9 g/cc, from about 0.3 g/cc to about 0.6 g/cc, from about 0.35 g/cc to about 0.8 g/cc, from about 0.4 g/cc to about 0.7 g/cc, or about 0.5 g/cc to about 0.6 g/cc. Loose Bulk Density can be determined using any suitable method, including the method found in Example Set 1.

In certain embodiments, the nutritional powder has a vibrated bulk density of about 0.2 g/cc, about 0.3 g/cc, about 0.4 g/cc, about 0.5 g/cc, about 0.6 g/cc, about 0.7 g/cc, about 0.8 g/cc, about 0.9 g/cc, about 1 g/cc, from about 0.2 g/cc to about 1 g/cc, from about 0.3 g/cc to about 0.9 g/cc, from about 0.35 g/cc to about 0.8 g/cc, from about 0.4 g/cc to about 0.7 g/cc, about 0.5 g/cc to about 0.8 g/cc, about 0.5 g/cc to about 0.6 g/cc, or from about 0.4 g/cc to about 0.6 g/cc. Vibrated Bulk Density can be determined using any suitable method, including the method found in Example Set 1.

In certain embodiments, the nutritional powder has a specified volume flowability, including a volume flowability in units of flow factor of about 1 ff, about 2 ff, about 2.5 ff, about 3 ff, about 3.5 ff, about 4 ff, about 4.5 ff, about 5 ff, about 5.5 ff, about 6 ff, about 6.5 ff, about 7 ff, about 8 ff, about 9 ff, about 10 ff, about 11 ff, about 12 ff, about 13 ff, about 14 ff, about 15 ff, about 20 ff, from about 1 ff to about 15 ff, from about 1 ff to about 13 ff, from about 1 ff to about 11 ff, from about 1 ff to about 8 ff, from about 1 ff to about 5 ff, from about 1.5 ff to about 5 ff, from about 2 ff to about 15 ff, from about 2 ff to about 11 ff, from about 2 ff to about 8 ff, from about 2 ff to about 7 ff, from about 2 ff to about 5 ff, from about 2 ff to about 4 ff, from about 3 ff to about 15 ff, from about 3 ff to about 8 ff, from about 3 ff to about 7 ff, from about 3 ff to about 5 ff, from about 4 ff to about 15 ff, from about 4 ff to about 11 ff, from about 4 ff to about 8 ff, or from about 4 ff to about 6 ff. Volume flowability in units of flow factor can be determined using any suitable method, including the method found in Example Set 1.

In certain embodiments, the nutritional powder has a moisture content of about 0.1%, about 0.2%, about 0.4%, about 0.6%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.2%, about 2.4%, about 2.6%, about 2.8%, about 3%, about 3.5%, about 4%, about 4.5%, about 5%, about 6%, from about 0.1% to about 6%, from about 1% to about 6%, from about 0.5% to about 5%, from about 1% to about 5%, from about 1% to about 2%, from about 1.5% to about 2.5%, from about 1.5% to about 3%, no more than about 6%, or no more than about 5%. Moisture content can be determined by weighing a powder sample before and after drying, and then dividing the change in weight upon drying by the weight of the sample prior to drying. The temperature used for drying can be any suitable temperature (e.g., 20° C., 30° C., 40° C., 50° C., 60° C., 70° C., 80° C., 90° C., or 100° C.) such as a temperature that does not result in decomposition of the sample and can be adjusted depending on the oven type (e.g., a vacuum oven, a convection oven, or a conventional oven). A sample can be dried for varying periods of time to attempt to remove all moisture from the sample, thereby providing a more accurate measure of moisture content.

The nutritional powder may comprise a wettability of about 1 second to about 200 seconds or about 1 second to about 30 seconds. The wettability of the nutritional powder can be measured indirectly by adding a powder to the surface of water in a container (e.g., a beaker) and recording the time it takes for the powder to fall below the surface. In some embodiments, the wettability can be from about 1 second to about 200 seconds, from about 1 second to about 150 seconds, from about 1 second to about 120 seconds, from about 1 second to about 20 seconds, from about 1 second to about 20 seconds, from about 2 seconds to about 200 seconds, from about 2 seconds to about 150 seconds, from about 2 seconds to about 120 seconds, from about 2 seconds to about 10 seconds, from about 1 second to about 5 seconds, from about 2 seconds to about 5 seconds, at least 1 second, at least 2 seconds, no more than 200 seconds, no more than 150 seconds, or no more than 120 seconds.

In certain embodiments, the size and shape of the nutritional powder particles can be characterized by a variety of parameters such as, for example, aspect ratio, circularity, convexity, elongation, high sensitivity (HS) circularity, solidity fiber elongation, fiber straightness, or the like. In certain embodiments, the nutritional powder comprises particles that are flakes, spheroidal, cuboidal, plates, rods, threads, and combinations thereof. As used herein, the term cuboidal is intended to encompass cubes and cube-like shapes (i.e., non-perfect cubes). As used herein, the term spheroidal is intended to encompass spheres and sphere-like shapes (i.e., non-perfect spheres such as ellipses). In certain embodiments, the nutritional powder comprises particles wherein a majority of the particles (on a weight percent basis) are flakes, spheroidal, cuboidal, plates, rods, threads, and combinations thereof. In some embodiments, the nutritional powder comprises particles wherein a majority of the particles (on a weight percent basis) have a non-spheroidal shape (e.g., are flakes, plates, rods, threads, or cuboidal).

In certain exemplary embodiments, the nutritional powder comprises particles comprising flake-shaped particles wherein a majority of the flake-shaped particles (on a weight percent basis) have a width, a length, or both that is at least about 5% larger, at least about 7% larger, at least about 10% larger, at least about 15% larger, or at least about 20% larger than its thickness.

The morphology of the particles of the nutritional powder may be analyzed according to any suitable method, including, but limited to, by use of a Malvern Morphologi G3 particle characterization system, which measures the size and shape of particles via static image analysis. For example, any number of measures of particle shape can be determined (e.g., by use of a Malvern Morphologi G3 particle characterization system or any suitable system) including but not limited to, convexity, circularity, non-circularity, circular equivalent diameter, and aspect ratio. In certain embodiments, the size of the particles of the nutritional powder may additionally or otherwise be evaluated via a laser diffraction particle size analyzer, such as, for example, a Sympatec HELOS Model 1005 laser diffraction sensor including a laser operating at 632.8 nm. In certain exemplary embodiments, the nutritional powder comprises particles having a particle distribution from about 1 μm to about 1 mm (based on the D10, D50, and D90 particle size values). In the D10, D50, and D90 distribution description, D10 indicates that 10% of particles have a diameter below D10 diameter, D50 indicates that 50% of particles have a diameter below the D50 diameter (this is the median particle size), and D90 indicates that 90% of particles have a diameter below the D90 diameter. In certain exemplary embodiments, the nutritional powder comprises particles having a mean particle size from about 25 μm to about 1 mm. As used herein, “mean particle size” refers to the average diameter of all the particles in a powder sample, determined based on the particle size distribution as measured by the laser diffraction particle size analyzer.

In some embodiments, the nutritional powder comprises particles that have a mean particle size of from about 25 μm to about 1000 μm in diameter, including from about 25 μm to about 750 μm, including from about 25 μm to about 500 μm, including from about 25 μm to about 400 μm, including from about 25 μm to about 200 μm, including from about 40 μm to about 1000 μm, including from about 40 μm to about 750 μm, including from about 40 μm to about 500 μm, including from about 40 μm to about 400 μm, including from about 40 μm to about 200 μm, including from about 60 μm to about 1000 μm, including from about 60 μm to about 750 μm, including from about 60 μm to about 500 μm, including from about 60 μm to about 600 μm, including from about 60 μm to about 400 μm, including from about 60 μm to about 200 μm, including from about 80 μm to about 1000 μm, including from about 80 μm to about 750 μm, including from about 80 μm to about 500 μm, including from about 80 μm to about 400 μm, including from about 80 μm to about 200 μm, including from about 90 μm to about 1000 μm, including from about 90 μm to about 750 μm, including from about 90 μm to about 500 μm, including from about 90 μm to about 400 μm, including from about 90 μm to about 300 μm, including from about 90 μm to about 200 μm, including from about 90 μm to about 150 μm, including from about 100 μm to about 1000 μm, including from about 100 μm to about 750 μm, including from about 100 μm to about 500 μm, including from about 100 μm to about 400 μm, including from about 100 μm to about 300 μm, including from about 100 μm to about 200 μm, including from about 100 μm to about 150 μm, including from about 150 μm to about 1000 μm, including from about 150 μm to about 750 μm, including from about 150 μm to about 500 μm, including from about 150 μm to about 400 μm, including from about 150 μm to about 300 μm, and including from about 150 μm to about 200 μm. Suitable mean particle sizes include about 25 μm, about 40 μm, about 60 μm, about 80 μm, about 90 μm, about 95 μm, about 100 μm, about 110 μm, about 115 μm, about 120 μm, about 125 μm, about 150 μm, about 160 μm, about 165 μm, about 175 μm, about 200 μm, about 205 μm, about 210 μm, about 250 μm, about 300 μm, about 350 μm, about 380 μm, about 400 μm, about 450 μm, about 500 μm, about 550 μm, about 600 μm, about 650 μm, about 700 μm, about 800 μm, about 900 μm, and about 1000 μm.

In certain embodiments, the nutritional powder has a particle size distribution where at least about 90% (by particle number) of the particles have a particle size below (see D90 discussed above) of from about 25 μm to about 1000 μm, from about 25 μm to about 800 μm, from about 25 μm to about 750 μm, from about 25 μm to about 500 μm, from about 25 μm to about 400 μm, from about 40 μm to about 1000 μm, from about 40 μm to about 800 μm, from about 40 μm to about 750 μm, from about 40 μm to about 600 μm, from about 40 μm to about 500 μm, from about 40 μm to about 400 μm, from about 50 μm to about 1000 μm, from about 50 μm to about 800 μm, from about 50 μm to about 750 μm, from about 50 μm to about 600 μm, from about 50 μm to about 500 μm, from about 50 μm to about 400 μm, from about 60 μm to about 1000 μm, from about 60 μm to about 800 μm, from about 60 μm to about 750 μm, from about 60 μm to about 600 μm, from about 60 μm to about 500 μm, from about 60 μm to about 400 μm, from about 70 μm to about 1000 μm, from about 70 μm to about 800 μm, from about 70 μm to about 750 μm, from about 70 μm to about 600 μm, from about 70 μm to about 500 μm, from about 70 μm to about 400 μm, from about 150 μm to about 1000 μm, from about 150 μm to about 800 μm, from about 150 μm to about 750 μm, from about 150 μm to about 600 μm, from about 150 μm to about 500 μm, and from about 150 μm to about 400 μm. In certain embodiments, at least about 50% by weight of the nutritional powder particles have particle sizes from about 25 μm to about 1000 μm, from about 25 μm to about 750 μm, from about 25 μm to about 500 μm, from about 25 μm to about 400 μm, from about 40 μm to about 1000 μm, from about 40 μm to about 750 μm, from about 40 μm to about 600 μm, from about 40 μm to about 500 μm, from about 40 μm to about 400 μm, from about 50 μm to about 1000 μm, from about 50 μm to about 750 μm, from about 50 μm to about 600 μm, from about 50 μm to about 500 μm, from about 50 μm to about 400 μm, from about 60 μm to about 1000 μm, from about 60 μm to about 750 μm, from about 60 μm to about 600 μm, from about 60 μm to about 500 μm, from about 60 μm to about 400 μm, from about 70 μm to about 1000 μm, from about 70 μm to about 750 μm, from about 70 μm to about 600 μm, from about 70 μm to about 500 μm, and from about 70 μm to about 400 μm. In certain embodiments, at least about 50% (by particle numbers) of the nutritional powder particles have particle sizes (see D50 discussed above) from about 25 μm to about 1000 μm, from about 25 μm to about 750 μm, from about 25 μm to about 500 μm, from about 25 μm to about 400 μm, from about 40 μm to about 1000 μm, from about 40 μm to about 750 μm, from about 40 μm to about 600 μm, from about 40 μm to about 500 μm, from about 40 μm to about 400 μm, from about 50 μm to about 1000 μm, from about 50 μm to about 750 μm, from about 50 μm to about 600 μm, from about 50 μm to about 500 μm, from about 50 μm to about 400 μm, from about 60 μm to about 1000 μm, from about 60 μm to about 750 μm, from about 60 μm to about 600 μm, from about 60 μm to about 500 μm, from about 60 μm to about 400 μm, from about 70 μm to about 1000 μm, from about 70 μm to about 750 μm, from about 70 μm to about 600 μm, from about 70 μm to about 500 μm, and from about 70 μm to about 400 μm. In certain embodiments, the nutritional powder has a particle size distribution where at least about 10% (by particle numbers) of the particles have a particle size (see D10 discussed above) of from about 1 μm to about 300 μm, from about 1 μm to about 200 μm, from about 1 μm to about 100 μm, from about 1 μm to about 75 μm, from about 5 μm to about 300 μm, from about 5 μm to about 200 μm, from about 5 μm to about 100 μm, from about 5 μm to about 75 μm, from about 10 μm to about 300 μm, from about 10 μm to about 200 μm, from about 10 μm to about 100 μm, or from about 10 μm to about 75 μm.

As those of skill in the art will understand, another measurement used to characterize the shape of non-spheroidal particles is aspect ratio; “aspect ratio” is defined as particle's shortest dimension divided by the particle's longest dimension. In certain embodiments, the nutritional powder comprises particles having an aspect ratio of from about 0.1 to about 1. In some embodiments, the nutritional powder comprises particles having an aspect ratio of from 0.2 to about 1, from 0.3 to about 1, from about 0.4 to about 1, from about 0.5 to about 1, from about 0.7 to about 1, from about 0.1 to about 0.9, from about 0.5 to about 0.9, or from about 0.7 to about 0.9. In certain embodiments, the nutritional powder comprises particles wherein about 50 weight % (% wt) or more (including about 60% wt or more, about 70% wt or more, about 80% wt or more, about 90% wt or more, about 95% wt or more, about 50 to about 100% wt, about 50 to about 99% wt, about 59 to about 95% wt, about 50 to about 90% wt, about 50 to about 80% wt, about 60 to about 100% wt, about 60 to about 99% wt, about 60 to about 95% wt, about 60 to about 90% wt, about 60 to about 80% wt, about 70 to about 100% wt, about 70 to about 99% wt, about 70 to about 95% wt, about 70 to about 90% wt, about 70 to about 80% wt, about 80 to about 100% wt, about 80 to about 99% wt, about 80 to about 95% wt, about 80 to about 90% wt, about 90 to about 100% wt, about 90 to about 99% wt, and about 90 to about 95% wt) of the particles have an aspect ratio of from about 0.1 to about 1. In certain embodiments, the nutritional powder comprises particles wherein about 50 weight % (% wt) or more (including about 60% wt or more, about 70% wt or more, about 80% wt or more, about 90% wt or more, about 95% wt or more, about 50 to about 100% wt, about 50 to about 99% wt, about 59 to about 95% wt, about 50 to about 90% wt, about 50 to about 80% wt, about 60 to about 100% wt, about 60 to about 99% wt, about 60 to about 95% wt, about 60 to about 90% wt, about 60 to about 80% wt, about 70 to about 100% wt, about 70 to about 99% wt, about 70 to about 95% wt, about 70 to about 90% wt, about 70 to about 80% wt, about 80 to about 100% wt, about 80 to about 99% wt, about 80 to about 95% wt, about 80 to about 90% wt, about 90 to about 100% wt, about 90 to about 99% wt, and about 90 to about 95% wt) of the particles have an aspect ratio of from about 0.1 to about 0.9.

In some embodiments, the nutritional powder comprises particles that have a convexity of from about 0.9 to about 0.995. “Convexity” as used herein is defined as the particle's convex hull perimeter divided by the actual particle perimeter, and is unitless. The particle's convex hull perimeter is the smallest convex set that contains all the points of the actual particle parameter (e.g., the convex hull may be visualized as the shape enclosed by a rubber band stretched around the particle). In some embodiments, the nutritional powder comprises particles having a convexity of about 0.9, about 0.91, about 0.92, about 0.93, about 0.935, about 0.94, about 0.945, about 0.95, about 0.955, about 0.96, about 0.965, about 0.97, about 0.975, about 0.98, about 0.985, about 0.99, about 0.995, at least about 0.9, at least about 0.92, at least about 0.93, at least about 0.94, from about 0.9 to about 0.995, from about 0.9 to about 0.99, from about 0.9 to about 0.98, from about 0.9 to about 0.97, from about 0.9 to about 0.96, from about 0.94 to about 0.995, from about 0.94 to about 0.99, from about 0.94 to about 0.98, from about 0.94 to about 0.97, from about 0.94 to about 0.96, from about 0.95 to about 0.995, from about 0.95 to about 0.99, from about 0.95 to about 0.98, from about 0.95 to about 0.97, or from about 0.95 to about 0.96.

In some embodiments, the nutritional powder comprises particles that have a circularity of from about 0.8 to about 0.99. “Circularity” as used herein is defined as the circumference of the circle of equivalent area divided by the actual perimeter of the particle, and is unitless. In some embodiments, the nutritional powder comprises particles having a circularity of about 0.8, about 0.81, about 0.82, about 0.83, about 0.84, about 0.85, about 0.86, about 0.87, about 0.88, about 0.89, about 0.9, about 0.91, about 0.92, about 0.93, about 0.94, about 0.95, about 0.96, about 0.97, about 0.98, about 0.99, from about 0.85 to about 0.99, from about 0.85 to about 0.97, at least about 0.85, at least about 0.87, at least about 0.88, at least about 0.89, from about 0.85 to about 0.95, from about 0.85 to about 0.93, from about 0.85 to about 0.92, from about 0.88 to about 0.99, from about 0.88 to about 0.97, from about 0.88 to about 0.95, from about 0.88 to about 0.93, from about 0.88 to about 0.92, from about 0.9 to about 0.99, from about 0.9 to about 0.97, from about 0.9 to about 0.95, from about 0.9 to about 0.93, or from about 0.9 to about 0.92.

In some embodiments, the nutritional powder comprises particles that have a non-circularity of from about 20% to about 90%. “Non-circularity” as used herein is defined as the number percentage of particles with circularity below 0.95. In some embodiments, the nutritional powder comprises particles having a non-circularity of about 20%, about 25%, about 30%, about 35%, about 40%, about 45%, about 50%, about 55%, about 60%, about 65%, about 70%, about 75%, about 80%, about 85%, about 90%, at least about 20%, at least about 25%, at least about 30%, from about 20% to about 80%, from about 20% to about 75%, from about 20% to about 70%, from about 25% to about 80%, from about 25% to about 75%, from about 25% to about 70%, from about 30% to about 80%, from about 30% to about 75%, from about 30% to about 70%, from about 50% to about 80%, from about 50% to about 75%, or from about 50% to about 70%.

In some embodiments, the nutritional powder comprises particles that have a surface area (in units of m²/g) of from about 0.01 to about 0.5. Surface area can be measured by any suitable method such as the Brunauer-Emmett-Teller (BET) multilayer gas adsorption method using, for example, the Micromeritics TriStar II 3020 surface area and porosity analyzer using Krypton option. In some embodiments, the nutritional powder comprises particles that have a surface area (in units of m²/g) of about 0.01, about 0.02, about 0.03, about 0.04, about 0.05, about 0.06, about 0.07, about 0.08, about 0.09, about 0.1, about 0.11, about 0.12, about 0.13, about 0.14, about 0.15, about 0.16, about 0.17, about 0.18, about 0.19, about 0.2, about 0.25, about 0.3, about 0.35, about 0.4, about 0.45, about 0.5, from about 0.01 to about 0.5, from about 0.01 to about 0.2, from about 0.01 to about 0.1, from about 0.02 to about 0.5, from about 0.02 to about 0.2, from about 0.02 to about 0.1, from about 0.04 to about 0.5, from about 0.04 to about 0.2, from about 0.04 to about 0.1, from about 0.05 to about 0.5, from about 0.05 to about 0.2, or from about 0.05 to about 0.1.

### Macronutrients

As discussed above, in certain embodiments, the nutritional powder comprises one or more macronutrients selected from the group of protein, carbohydrate, fat, and mixtures thereof. In certain embodiments, the nutritional powders comprise at least one source of protein, at least one source of carbohydrate, and at least one source of fat. Generally, any source of protein, carbohydrate, or fat that is suitable for use in nutritional products is also suitable for use herein, provided that such macronutrients are also compatible with the essential elements of the nutritional powders as defined herein.

Although total concentrations or amounts of protein, carbohydrates, and fat may vary depending upon the nutritional needs of the particular individual for whom the nutritional powder is formulated, such concentrations or amounts most typically fall within one of the following embodied ranges, inclusive of any other essential protein, carbohydrate, or fat ingredients as described herein.

In certain embodiments, when the nutritional powder is formulated as an infant formula, the protein component is typically present in an amount of from about 5% to about 35% by weight of the infant formula (i.e., the powder infant formula), including from about 10% to about 30%, from about 10% to about 25%, from about 15% to about 25%, from about 20% to about 30%, from about 15% to about 20%, and also including from about 10% to about 16% by weight of the infant formula (i.e., the powder infant formula). The carbohydrate component is typically present in an amount of from about 40% to about 75% by weight of the infant formula (i.e., the powder infant formula), including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant formula (i.e., the powder infant formula). The fat component is typically present in an amount of from about 10% to about 40% by weight of the infant formula (i.e., the powder infant formula), including from about 15% to about 40%, from about 20% to about 35%, from about 20% to about 30%, from about 25% to about 35%, and also including from about 25% to about 30% by weight of the infant formula (i.e., the powder infant formula).

In certain embodiments, when the nutritional powder is formulated as a pediatric formula, the protein component is typically present in an amount of from about 5% to about 35% by weight of the pediatric formula (i.e., the powder pediatric formula), including from about 5% to about 30%, from about 10% to about 25%, from about 10% to about 20%, from about 10% to about 15%, from about 15% to about 20%, and also including from about 12% to about 20% by weight of the pediatric formula (i.e., the powder pediatric formula). The carbohydrate component is typically present in an amount of from about 40% to about 75% by weight of the pediatric formula (i.e., the powder pediatric formula), including from about 45% to about 70%, from about 50% to about 70%, from about 55% to about 70%, and also including from about 55% to about 65% by weight of the pediatric formula (i.e., the powder pediatric formula). The fat component is typically present in an amount of from about 10% to about 25% by weight of the pediatric formula (i.e., the powder pediatric formula), including from about 12% to about 20%, and also including from about 15% to about 20% by weight of the pediatric formula (i.e., the powder pediatric formula).

Additional suitable ranges for proteins, carbohydrates, and fats in those embodiments where the nutritional powder is formulated as an infant formulas or a pediatric formula, based on the percentage of total calories of the nutritional powder, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional powder is formulated as an adult nutritional product (i.e., the powder adult nutritional product), the protein component is typically present in an amount of from about 5% to about 35% by weight of the adult nutritional product, including from about 10% to about 30%, from about 10% to about 20%, from about 15% to about 20%, and including from about 20% to about 30% by weight of the adult nutritional product (i.e., the powder adult nutritional product). The carbohydrate component is typically present in an amount of from about 40% to about 80% by weight of the adult nutritional product (i.e., the powder adult nutritional product), including from about 50% to about 75%, from about 50% to about 65%, from about 55% to about 70%, and also including from 60% to 75% by weight of the adult nutritional product (i.e., the powder adult nutritional product). The fat component is typically present in an amount of from about 0.5% to about 20%, including from about 1% to about 15%, from about 1% to about 10%, from about 1% to about 5%, from about 5% to about 20%, from about 10% to about 20%, and also including from about 15% to about 20% by weight of the adult nutritional product (i.e., the powder adult nutritional product).

Additional suitable ranges for proteins, carbohydrates, and fats in those embodiments where the nutritional powder is formulated as an adult nutritional product, based on the percentage of total calories of the nutritional powder, are set forth in Table 2.

TABLE 2

| | Embodiment D | Embodiment E | Embodiment F |
|---|---|---|---|
| Macronutrient | (% Calories) | (% Calories) | (% Calories) |
| Carbohydrate | 1-98 | 0-75 | 20-50 |
| Fat | 1-98 | 20-70 | 25-40 |
| Protein | 1-98 | 5-80 | 15-55 |

Note:
Each numerical value in the table is preceded by the term “about.”

In certain embodiments, the nutritional powder includes protein or a source of protein. Generally, any source of protein may be used so long as it is suitable for oral nutritional compositions and is otherwise compatible with any other selected ingredients or features in the nutritional composition. Non-limiting examples of suitable proteins (and sources thereof) suitable for use in the nutritional powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) used in the nutritional powders disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders described herein may include any individual source of protein or combination of the various sources of protein listed above.

In addition, the proteins for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof.

In certain embodiments, the nutritional powders described herein include a protein component that consists of only intact or partially hydrolyzed protein; that is, the protein component is substantially free of any protein that has a degree of hydrolysis of 25% or more. In this context, the term “partially hydrolyzed protein” refers to proteins having a degree of hydrolysis of less than 25%, including less than 20%, including less than 15%, including less than 10%, and including proteins having a degree of hydrolysis of less than 5%. The degree of hydrolysis is the extent to which peptide bonds are broken by a hydrolysis chemical reaction. To quantify the partially hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

In certain embodiments, the nutritional powder includes a carbohydrate or a source of carbohydrate. The carbohydrate or source of carbohydrate suitable for use in the nutritional powders disclosed herein may be simple, complex, or variations or combinations thereof. Generally, the carbohydrate may include any carbohydrate or carbohydrate source that is suitable for use in oral nutritional compositions and is otherwise compatible with any other selected ingredients or features in the nutritional powder. It should be noted, however, the inventors have discovered, that in some embodiments, certain carbohydrates, when used at high concentrations, may be unsuitable for the nutritional powders of the present disclosure, because these carbohydrates may cause plugging in the beverage production machine. For example, in certain embodiments, it has been found that nutritional powders containing some types of rice starch at a concentration of about 15% or more of the total weight of the nutritional powder are more prone to plugging the beverage production machine.

Non-limiting examples of carbohydrates suitable for use in the nutritional powders described herein include, but are not limited to, polydextrose; maltodextrin; hydrolyzed or modified starch or cornstarch; glucose polymers; corn syrup; corn syrup solids; rice-derived carbohydrate; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low and high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The nutritional powders described herein may include any individual source of carbohydrate or combination of the various sources of carbohydrate listed above.

In certain embodiments, the nutritional powder includes a fat or a source of fat. The fat or source of fat suitable for use in the nutritional powders described herein may be derived from various sources including, but not limited to, plants, animals, and combinations thereof. Generally, the fat may include any fat or fat source that is suitable for use in oral nutritional compositions and is otherwise compatible with any other selected ingredients or features in the nutritional powder. Non-limiting examples of suitable fat (or sources thereof) for use in the nutritional powders disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used in nutritional powders for formulating infant formulas and pediatric formulas provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders can include any individual source of fat or combination of the various sources of fat listed above.

### Optional Ingredients

In certain embodiments, the nutritional powders described herein may further comprise other optional ingredients that may modify the physical, chemical, hedonic, or processing characteristics of the products or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors (natural, artificial, or both), thickening agents, flow agents, anti-caking agents, and stabilizers.

In certain embodiments, the nutritional powder further comprises minerals, non-limiting examples of which include calcium, phosphorus, magnesium, iron, zinc, manganese, copper, sodium, potassium, molybdenum, chromium, selenium, chloride, and combinations thereof.

In certain embodiments, the nutritional powder further comprises vitamins or related nutrients, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

In certain embodiments, the nutritional powder includes one or more masking agents to reduce or otherwise obscure bitter flavors and after taste. Suitable masking agents include natural and artificial sweeteners, natural and artificial flavors, sodium sources such as sodium chloride, and hydrocolloids, such as guar gum, xanthan gum, carrageenan, gellan gum, and combinations thereof. Generally, the amount of masking agent in the nutritional powder may vary depending upon the particular masking agent selected, other ingredients in the nutritional powder, and other nutritional powder or product target variables. Such amounts, however, most typically range from at least 0.1 wt %, including from about 0.15 wt % to about 3 wt %, and also including from about 0.18 wt % to about 2.5 wt %, by weight of the nutritional powder.

In certain embodiments, the nutritional powder includes at least one wetting agent. Generally, wetting agents act to improve and hasten the interaction between the nutritional powder and the impinging liquid, typically water, supplied by the beverage production machine. The wetting agent thus assists in quickly reconstituting the nutritional powder into a suitable liquid product. Suitable wetting agents include phospholipids, mono- and di-glycerides, diacetyl tartaric acid ester of mono- and diglycerides (DATEM), and other emulsifiers and surfactants.

In some embodiments, the nutritional powders include at least flow agent or one anti-caking agent. These agents can, in certain instances, maintain the powder particles as loose, free-flowing particles with a reduced tendency to clump (e.g., as the powder sits over time). An example of a suitable flow agent or one anti-caking agent is silicon dioxide, tricalcium phosphate, and silicates. The concentration of the flowing agent or anti-caking agent in the nutritional powder can vary depending upon the product form, the other selected ingredients, the desired flow properties, and so forth. The concentration of the flowing agent or anti-caking agent in the nutritional powder can range from about 0.1% to about 4%, including from about 0.5% to about 2%, by weight of the nutritional powder.

In certain embodiments, the nutritional powder comprises a compound selected from the group of leucine, beta-alanine, epigallocatechin gallate, human milk oligosaccharides, prebiotics, probiotics, nucleotides, nucleosides, carotenoids (e.g., lutein, beta-carotene, lycopene, zeaxanthin), beta-hydroxy-beta-methylbutyrate (HMB), and combinations thereof. Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product.

The nutritional compositions disclosed herein may also be substantially free of any optional ingredient or feature described herein, provided that the remaining nutritional composition still contains all of the required ingredients or features as described herein. In this context, and unless otherwise specified, the term “substantially free” means that the selected nutritional compositions contain less than a functional amount of the optional ingredient, such as less than about 0.5%, less than about 0.1% or about zero, by weight of such optional ingredient.

### Product Form

The nutritional powders useful in the methods of the present disclosure may be formulated in any known or otherwise suitable product form for oral or parenteral administration. Oral product forms are generally preferred and include any solid, liquid, or powder formulation suitable for use herein, provided that such a formulation allows for safe and effective oral delivery of the essential and other selected ingredients from the selected product form.

In certain embodiments, the nutritional powder pod contains a nutritional powder that is one of the following: an infant formula, a pediatric formula, an adult nutritional formula, a human milk fortifier, a preterm infant formula, an elemental formula, a semi-elemental formula, or a nutritional supplement. In certain embodiments, when the nutritional powder is an infant formula, the nutritional powder pod, the packaging for the nutritional powder pods, or both are labeled with information indicating that the formula within is an infant formula and is intended for consumption by infants. In certain embodiments, when the nutritional powder is a pediatric formula, the nutritional powder pod, the packaging for the nutritional powder pods, or both are labeled with information indicating that the formula within is a pediatric formula and is intended for consumption by toddlers, children, or both. In certain embodiments, when the nutritional powder is an adult nutritional formula, the nutritional powder pod, the packaging for the nutritional powder pods, or both are labeled with information indicating that the formula within is an adult nutritional formula and is intended for consumption by adults. In certain embodiments, when the nutritional powder is an adult formula, the nutritional powder includes one or more flavorings, examples of which include, but are not limited to vanilla, chocolate, fruit flavors, vegetable flavors, coffee, and butter pecan.

The nutritional powder can, in certain embodiments, be contained in the pod such that a headspace in the pod includes a maximum of about 10% O₂ (e.g., no more than about 10% O₂, no more than about 8% O₂, no more than about 6% O₂, no more than about 5% O₂, no more than about 4% O₂, no more than about 2% O₂, or no more than about 1% O₂), thereby reducing oxidation of the nutritional powder or formula and preventing the development of undesirable flavors, smells, and textures.

In certain embodiments, the pod body can be molded or otherwise constructed of a food-safe material, including but not limited to a plastic (e.g., polypropylene or polyethylene), metal, natural product (e.g., paper or other fiber based material), and combinations thereof.

The nutritional powders may be formulated with sufficient kinds and amounts of nutrients to provide a sole, primary, or supplemental source of nutrition, or to provide a specialized nutritional product for use in individuals afflicted with specific diseases or conditions or with a targeted nutritional benefit. In certain exemplary embodiments, the nutritional powder will include protein, fat, and carbohydrate.

Generally, when preparing a liquid product from a nutritional powder, it is desirable that the nutritional powder be accurately and fully incorporated into the beverage. It can be undesirable, for instance, for there to be a residue of dry nutritional powder left at the bottom of a container or for the nutritional powder to form clumps that fail to reconstitute in the liquid product. In some instances, this can be particularly important with infant formulas, because these formulas typically provide the sole source or a supplemental source of nourishment to the infant. Generally, in some embodiments, an infant formula powder must be fully reconstituted, so the infant receives a full serving of nutrients and calories provided by the formula. Additionally, any unreconstituted nutritional powder left within the nutritional powder pod is typically discarded, which is wasteful both economically and environmentally. As well, within a beverage production machine, any unreconstituted powder may create clumps that can deposit within or clog the inner workings of the machine, which can cause machine failure or create sites for microbial growth and contamination.

For these reasons, in certain embodiments, the nutritional powder in the nutritional powder pod is essentially reconstituted into the liquid product by the beverage production machine. In certain embodiments, essentially reconstituted means that the reconstitution yield of the nutritional powder in the liquid product is at least about 75% (i.e., about 75% to about 100%). In other embodiments, the reconstitution yield of the nutritional powder in the liquid product can be at least about 75%, at least about 80%, at least about 85%, at least about 90%, at least about 92%, at least about 95%, at least about 98%, at least about 99%, at least about 100%, about 75% to about 100%, about 75% to about 99%, about 75% to about 98%, about 75% to about 95%, about 75% to about 90%, about 75% to about 85%, about 80% to about 100%, about 80% to about 99%, about 80% to about 98%, about 80% to about 95%, about 80% to about 90%, about 85% to about 100%, about 85% to about 99%, about 85% to about 98%, about 85% to about 95%, about 90% to about 100%, about 90% to about 98%, about 90% to about 95%, about 92% to about 100%, about 92% to about 98%, about 95% to about 100%, and about 95% to about 98%, 80%-100%, 80%-98%, 80%-95%, 85%-100%, 85%-98%, 85%-95%, 90%-100%, 90%-98%, 90%-95%, 92%-100%, 92%-98%, 92%-95%, 95%-100%, 95%-98%, and 98%-100%. Reconstitution yield can be determined using any suitable method including the procedures found in Example Set 4. Generally a beverage production machine places certain limitations on the conditions under which reconstitution takes place. For example, the beverage production machine may inject a specified volume of liquid at a specified temperature into the nutritional powder pod.

In certain embodiments, the liquid product comprises at least about 75 weight percent (% wt) of the nutritional powder in the nutritional powder pod. In other embodiments, the liquid product comprises at least about 80% wt, at least about 85% wt, at least about 90% wt, at least about 92% wt, at least about 95% wt, at least about 98% wt, at least about 100% wt, and about 75% wt to about 100% wt, about 75% wt to about 98% wt, about 75% wt to about 95% wt, about 75% wt to about 90% wt, about 75% wt to about 85% wt, about 80% wt to about 100% wt, about 80% wt to about 98% wt, about 80% wt to about 95% wt, about 80% wt to about 90% wt, about 85% wt to about 100% wt, about 85% wt to about 98% wt, about 85% wt to about 95% wt, about 90% wt to about 100% wt, about 90% wt to about 98% wt, about 90% wt to about 95% wt, about 92% wt to about 100% wt, about 92% wt to about 98% wt, about 95% wt to about 100% wt, and about 95% wt to about 98% wt, 90% wt-100% wt, 90% wt-98% wt, 90% wt-95% wt, 92% wt-100% wt, 92% wt-98% wt, 92% wt-95% wt, 95% wt-100% wt, 95% wt-98% wt, and 98% wt-100% wt of the weight of the nutritional powder in the nutritional powder pod.

In other embodiments, the weight percent (% wt) of the nutritional powder in the nutritional powder pod that is mixed with the liquid can be at least about 75% wt, at least about 80% wt, at least about 85% wt, at least about 90% wt, at least about 92% wt, at least about 95% wt, at least about 98% wt, at least about 100% wt, and about 75% wt to about 100% wt, about 75% wt to about 98% wt, about 75% wt to about 95% wt, about 75% wt to about 90% wt, about 75% wt to about 85% wt, about 80% wt to about 100% wt, about 80% wt to about 98% wt, about 80% wt to about 95% wt, about 80% wt to about 90% wt, about 85% wt to about 100% wt, about 85% wt to about 98% wt, about 85% wt to about 95% wt, about 90% wt to about 100% wt, about 90% wt to about 98% wt, about 90% wt to about 95% wt, about 92% wt to about 100% wt, about 92% wt to about 98% wt, about 95% wt to about 100% wt, and about 95% wt to about 98% wt, 90% wt-100% wt, 90% wt-98% wt, 90% wt-95% wt, 92% wt-100% wt, 92% wt-98% wt, 92% wt-95% wt, 95% wt-100% wt, 95% wt-98% wt, and 98% wt-100% wt of the weight of the nutritional powder in the nutritional powder pod.

In certain exemplary embodiments, liquid is mixed with the nutritional powder of the nutritional powder pod, where the liquid is at a temperature from about 5° C. to about 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., including about 40° C. to about 50° C. In certain embodiments, the liquid is mixed with the nutritional powder from the nutritional powder pod, where the liquid is at a temperature of from about 5° C. to about 15° C., or from about 25° C. to about 50° C.

In certain embodiments, liquid is mixed with the nutritional powder of the nutritional powder pod to provide a liquid product that has a temperature from about 5° C. to about 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., including about 40° C. to about 50° C. In certain embodiments, the liquid is mixed with the nutritional powder of the nutritional powder pod to provide a liquid product that has a temperature of from about 5° C. to about 15° C., or from about 25° C. to about 50° C.

In certain exemplary embodiments, the volume of liquid mixed with the nutritional powder can be from about 5 mL to about 1 L, from about 25 mL to about 1 L, or from about 5 mL to about 250 mL. In other embodiments, the volume of liquid mixed with the nutritional powder can be from about 1 fluid ounce to about 10 fluid ounces (about 25 mL to about 300 mL), including about 1 fluid ounce (about 25 mL), including about 2 fluid ounces (about 60 mL), including about 4 fluid ounces (about 100 mL), including about 8 fluid ounces (about 240 mL), including about 18 fluid ounces (about 500 mL), or including about 36 fluid ounces (about 1 L). In certain of the foregoing embodiments, the liquid is introduced within the nutritional powder pod to mix with the nutritional powder. In certain embodiments, the total volume of liquid used to reconstitute the liquid product is from about 1 fluid ounce to about 36 fluid ounces (about 25 mL to about 1 L) or from about 1 fluid ounce to about 18 fluid ounces (about 25 mL to about 500 mL).

In certain exemplary embodiments, the volume of liquid product dispensed can be from about 5 mL to about 1 L, from about 25 mL to about 1 L, or from about 5 mL to about 250 mL. In other embodiments, the volume of liquid product dispensed can be from about 1 fluid ounce to about 10 fluid ounces (about 25 mL to about 300 mL), including about 1 fluid ounce (about 25 mL), including about 2 fluid ounces (about 60 mL), including about 4 fluid ounces (about 100 mL), including about 8 fluid ounces (about 240 mL), including about 18 fluid ounces (about 500 mL), or including about 36 fluid ounces (about 1 L). In certain embodiments, the total volume of liquid product is from about 1 fluid ounce to about 36 fluid ounces (about 25 mL to about 1 L) or from about 1 fluid ounce to about 18 fluid ounces (about 25 mL to about 500 mL).

In certain embodiments, the nutritional powders are reconstituted into a liquid product in an amount of from about 10 g to about 150 g of powder per 200 mL of liquid, including from about 20 g/200 mL to about 125 g/200 mL, including from about 20 g/200 mL to about 100 g/200 mL, including from about 20 g/200 mL to about 80 g/200 mL, including from about 20 g/200 mL to about 65 g/200 mL, including from about 20 g/200 mL to about 50 g/200 mL, including from about 25 g/200 mL to about 150 g/200 mL, including from about 25 g/200 mL to about 125 g/200 mL, including from about 25 g/200 mL to about 100 g/200 mL, including from about 25 g/200 mL to about 80 g/200 mL, including from about 25 g/200 mL to about 65 g/200 mL, including from about 25 g/200 mL to about 50 g/200 mL, including from about 40 g/200 mL to about 150 g/200 mL, including from about 40 g/200 mL to about 125 g/200 mL, including from about 40 g/200 mL to about 100 g/200 mL, including from about 40 g/200 mL to about 80 g/200 mL, including from about 40 g/200 mL to about 65 g/200 mL, including from about 40 g/200 mL to about 50 g/200 mL, including about 50 g/200 mL to about 150 g/200 mL, including about 50 g/200 mL to about 125 g/200 mL, including about 50 g/200 mL to about 100 g/200 mL, including from about 50 g/200 mL to about 80 g/200 mL, including from about 50 g/200 mL to about 65 g/200 mL, including from about 60 g/200 mL to about 150 g/200 mL, including from about 60 g/200 mL to about 125 g/200 mL, and including about 60 g/200 mL to about 100 g/200 mL. The nutritional powders may also be reconstituted in an amount of 10 g of powder per 200 mL of liquid, 20 g per 200 mL, 25 g per 200 mL, 30 g per 200 mL, 40 g per 200 mL, 50 g per 200 mL, 60 g per 200 mL, 65 g per 200 mL, 75 g per 200 mL, 80 g per 200 mL, 100 g per 200 mL, 125 g per 200 mL, and 150 g of powder per 200 mL of liquid.

In certain embodiments, the pressure of the liquid introduced into the nutritional powder pod may affect the amount of air entrained in the resulting reconstituted liquid nutritional product. In certain exemplary embodiments, the liquid is injected into the nutritional powder pod at a pressure of from about 0.5 bar to about 15 bar. In certain exemplary embodiments, the liquid is injected into the nutritional powder pod at a pressure of from about 0.5 bar to about 15 bar, including from about 0.5 bar to about 10 bar, including from about 0.5 bar to about 7 bar, including from about 0.5 bar to about 5 bar, including from about 0.5 bar to about 2 bar, including about 0.5 bar to about 1 bar, including about 1 bar to about 10 bar, including about 2 bar to about 10 bar, including about 3 bar to about 10 bar, including about 5 bar to about 10 bar, and including about 2 bar to about 7 bar.

In certain exemplary embodiments, the nutritional powder is reconstituted within a defined period of time to render the liquid nutritional product suitable for oral consumption. In certain embodiments, the nutritional powder is reconstituted into the reconstituted nutritional liquid. In other exemplary embodiments, the reconstitution time is determined by measuring the time that elapses from the time a liquid (e.g., water) is added to nutritional powder to the time the reconstituted nutritional liquid (e.g., the nutritional product) was observed to be fully delivered to a collection bottle (e.g., a beverage container). In certain embodiments, the reconstitution time is no more than about 60 seconds (e.g., from about 50 seconds to about 60 seconds or from about 20 seconds to about 60 seconds), including a time of no more than about 50 seconds, including a time of no more than about 40 seconds, and including a time of no more than about 30 seconds. In other embodiments, the nutritional powder is reconstituted into the reconstituted nutritional liquid within a time of about 20 seconds, about 25 seconds, about 30 seconds, about 35 seconds, about 40 seconds, about 45 seconds, about 50 seconds, about 55 seconds, about 60 seconds, from about 20 seconds to about 50 seconds, from about 20 seconds to about 45 seconds, from about 20 seconds to about 40 seconds, from about 25 seconds to about 50 seconds, from about 25 seconds to about 45 seconds, or from about 25 seconds to about 40 seconds. Reconstitution time can be determined using any suitable method including that found in Example Set 4.

In certain embodiments, the nutritional powder has a rate of reconstitution at any given collection time of from about 0.1 mg/g-sec to about 30 mg/g-sec. In other embodiments, the nutritional powder has a rate of reconstitution at any given collection time (e.g., at the beginning of the run, at 15 seconds after the beginning of the run, or at 30 seconds after the beginning of the run) of about 0.1 mg/g-sec, about 0.15 mg/g-sec, about 0.2 mg/g-sec, about 0.25 mg/g-sec, about 0.3 mg/g-sec, about 0.4 mg/g-sec, about 0.45 mg/g-sec, about 0.5 mg/g-sec, about 0.55 mg/g-sec, about 0.6 mg/g-sec, about 0.65 mg/g-sec, about 0.7 mg/g-sec, about 0.75 mg/g-sec, about 0.8 mg/g-sec, about 0.85 mg/g-sec, about 0.9 mg/g-sec, about 0.95 mg/g-sec, about 1 mg/g-sec, about 1.2 mg/g-sec, about 1.4 mg/g-sec, about 1.6 mg/g-sec, about 1.8 mg/g-sec, about 2 mg/g-sec, about 2.3 mg/g-sec, about 2.6 mg/g-sec, about 3 mg/g-sec, about 3.5 mg/g-sec, about 4 mg/g-sec, about 4.5 mg/g-sec, about 5 mg/g-sec, about 5.5 mg/g-sec, about 6 mg/g-sec, about 6.5 mg/g-sec, about 7 mg/g-sec, about 7.5 mg/g-sec, about 8 mg/g-sec, about 8.5 mg/g-sec, about 9 mg/g-sec, about 9.5 mg/g-sec, about 9.9 mg/g-sec, about 10 mg/g-sec, about 12 mg/g-sec, about 15 mg/g-sec, about 17 mg/g-sec, about 20 mg/g-sec, about 22 mg/g-sec, about 25 mg/g-sec, about 30 mg/g-sec, no more than about 30 mg/g-sec, no more than about 25 mg/g-sec, no more than about 10 mg/g-sec, no more than about 8 mg/g-sec, no more than about 6 mg/g-sec, no more than about 5 mg/g-sec, from about 0.1 mg/g-sec to about 9 mg/g-sec, from about 0.5 mg/g-sec to about 8 mg/g-sec, from about 1 mg/g-sec to about 7 mg/g-sec, from about 3 mg/g-sec to about 10 mg/g-sec, from about 2 mg/g-sec to about 25 mg/g-sec, from about 2 mg/g-sec to about 20 mg/g-sec, from about 2 mg/g-sec to about 15 mg/g-sec, from about 5 mg/g-sec to about 25 mg/g-sec, from about 5 mg/g-sec to about 20 mg/g-sec, from about 5 mg/g-sec to about 15 mg/g-sec, from about 0.1 mg/g-sec to about 10 mg/g-sec, from about 0.1 mg/g-sec to about 5 mg/g-sec, from about 0.1 mg/g-sec to about 3 mg/g-sec, from about 0.5 mg/g-sec to about 10 mg/g-sec, from about 0.5 mg/g-sec to about 5 mg/g-sec, or from about 0.5 mg/g-sec to about 3 mg/g-sec. The rate of reconstitution can be determined using any suitable method including that found in Example Set 4.

In some embodiments, the liquid product may comprise a Hunter Lab “L” value from about 20 to about 100. The Hunter Lab “L” value is a measurement of the lightness of the formula. In certain embodiments, the Hunter Lab “L” value of the liquid product can be measured by a spectrophotometer, which allows quantitative measurement of the reflection or transmission properties of the formula as a function of wavelength. In some embodiments, the Hunter Lab “L” value of the liquid product can be about 20, about 30, about 40, about 50, about 60, about 70, about 80, about 90, about 100, from about 30 to about 90, from about 40 to about 80, from about 30 to about 100, from about 40 to about 100, from about 40 to about 90, from about 50 to about 70, or from about 50 to about 90.

In some embodiments, the liquid product may comprise a Hunter Lab “a” value from about −5 to about 1. The Hunter Lab “a” value is a measurement of the color-opponent dimension of a formula. In certain embodiments, the Hunter Lab “a” value of the liquid product can be measured by a spectrophotometer, which allows quantitative measurement of the reflection or transmission properties of the formula as a function of wavelength. In some embodiments, the Hunter Lab “a” value of the liquid product may be about −5, about −4, about −3, about −2, about −1, about 0, about 1, from about −4 to about 0, from about −3 to about −1, from about −3 to about 0, or from about −1 to about 1.

In some embodiments, the liquid product may comprise a Hunter Lab “b” value from about 1 to about 30. The Hunter Lab “b” value is a measurement of the color-opponent dimension of a formula. In certain embodiments, the Hunter Lab “b” value of the liquid product can be measured by a spectrophotometer, which allows quantitative measurement of the reflection or transmission properties of the formula as a function of wavelength. In some embodiments, the Hunter Lab “b” value of the liquid product may be about 1, about 2, about 5, about 10, about 15, about 20, about 25, about 30, from about 20 to about 30, from about 1 to about 25, from about 1 to about 20, from about 1 to about 15, from about 5 to about 30, from about 5 to about 25, from about 5 to about 20, from about 5 to about 15, from about 10 to about 30, from about 10 to about 25, from about 10 to about 20, from about 15 to about 30, from about 15 to about 20, or from about 20 to about 30.

### Methods of Manufacture

Generally, the nutritional powders used in the nutritional powder pods of the present disclosure may be prepared by any suitable manufacturing technique for preparing a nutritional powder. In some embodiments, at least a portion of the nutritional powder can include spray dried powders, dry blended powders, agglomerated powders, extruded powders, milled powders, powders prepared by other suitable methods, or combinations thereof. In certain embodiments, the process of preparing the nutritional powders includes spray drying, dry blending, agglomerating, extruding, milling, and combinations thereof.

In one suitable manufacturing process, an intermediary liquid is prepared using at least three separate slurries, including a protein-in-fat (PIF) slurry, a carbohydrate-mineral (CHO-MIN) slurry, and a protein-in-water (PIW) slurry. The PIF slurry is formed by heating and mixing the selected oils (e.g., canola oil, corn oil, fish oil, etc.) and then adding an emulsifier (e.g., lecithin), fat soluble vitamins, and a portion of the total protein (e.g., milk protein concentrate, etc.) with continued heat and agitation. The CHO-MIN slurry is formed by adding with heated agitation to water: minerals (e.g., potassium citrate, dipotassium phosphate, sodium citrate, etc.), trace and ultra trace minerals (TM/UTM premix), thickening or suspending agents (e.g., Avicel, gellan, carrageenan). The resulting CHO-MN slurry is held for 10 minutes with continued heat and agitation before adding additional minerals (e.g., potassium chloride, magnesium carbonate, potassium iodide, etc.) and/or carbohydrates (e.g., fructooligosaccharide, sucrose, corn syrup, etc.). The PIW slurry is then formed by mixing with heat and agitation the remaining protein (e.g., sodium caseinate, soy protein concentrate, etc.) into water.

Further to this example manufacturing process, the resulting slurries are then blended together with heated agitation and the pH adjusted to the desired range, typically from about 6.6 to about 7.5 (or from about 5.0 to about 7.5, or from about 5.0 to about 7.0, or from about 6.6 to about 7.0), after which the composition is subjected to high-temperature short-time (HTST) processing (i.e., about 165° F. (74° C.) for about 16 seconds) or ultra high temperature (UHT) processing (i.e., about 292° F. (144° C.) for about 5 seconds); during HTST processing or UHT processing the composition is heat treated, emulsified and homogenized, and then allowed to cool. Water soluble vitamins and ascorbic acid are added, the pH is again adjusted to the desired range if necessary. After drying, the powder may be transported to storage hoppers. The base powder may be dry blended with the remaining ingredients to form the nutritional powder. The nutritional powder is then packaged in appropriate containers (i.e., pods, packages containing one or more pods, or kits containing one or more pods) for distribution. Those of skill in the art will understand that standard intermediate manufacturing steps, such as bulk storage, packing in large bags or drums, transport to other locations, etc., may be incorporated as part of this process.

The nutritional powder, such as where a portion can be a spray-dried powder, an extruded powder, an agglomerated powder, or a dry-blended powder, may be prepared by any collection of known or otherwise effective techniques, suitable for making and formulating a nutritional powder.

For example, when the nutritional powder is a spray-dried, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried nutritional powders herein.

In other embodiments, the preparation of the nutritional powder comprises an extruded powder. Milling can also be included as a step in preparing the nutritional powder.

In certain embodiments, the ingredients of the nutritional powder may be extruded as part of the process of making the nutritional powder. In certain embodiments, the ingredients are incorporated in the extruder hopper in the form of a dry feed or powder premix. The dry nutritional ingredients enter the extruder just after the point of entry of water. In certain embodiments, the water comprises from about 1% to about 80% by weight of the total weight of the water and dry ingredients. The amount of water added to the nutritional composition may be adjusted within the aforementioned ranges based on the desired physical properties of the extrudate. In certain embodiments, the nutritional ingredients may be premixed with water to form a thick emulsion, which is then fed into the extruder hopper in the form of a viscous liquid or sludge. The term “extrudate” refers to all or a portion of a nutritional composition that exits an extruder.

In certain embodiments, the extruder is used to produce the nutritional powder or extrudate operates in a continuous format. Generally, any extruder known for use in food processing may be utilized. In certain embodiments, extrusion is performed via a screw extruder. Said screw extruder may be a twin screw extruder or a single screw extruder. The extruder screws may consist of shear elements, mixing elements, conveying elements, kneading elements, emulsifying elements, disc elements, or a combination of the above in any interchangeable order. The barrels of the extruder may be steam heated or electrically heated. In certain embodiments, extrusion takes place at a temperature from about 20° C. to about 99° C., from about 30° C. to about 150° C., or from about 70° C. to about 100° C. In certain embodiments, the ingredients are processed in the extruder for about 5 seconds to about 240 seconds or for about 30 seconds to about 180 seconds.

In certain embodiments disclosed herein, the extrudate is dried following extrusion so as to remove most or all of the water contained therein. In such embodiments, any conventional drying methods may be used to remove the desired amount of water from the nutritional powder. For example, the nutritional powder extrudate may be dried using a vacuum, convective hot air, a tray dryer, infrared, or any combination of the above. In some embodiments, the nutritional powder extrudate is dried at a temperature of from about 25° C. to about 225° C., including from about 50° C. to about 125° C., and including from about 70° C. to about 100° C. In some embodiments, the dried form of the nutritional powder extrudate comprises no more than about 7 weight percent water. In certain embodiments, the nutritional powder extrudate may be further ground or milled to a desired particle size following drying. In certain embodiments, additional protein and carbohydrate ingredients may be added to the final nutritional powder in the form of dry ingredients or a dry blend.

Other suitable methods for making nutritional powders are described, for example, in U.S. Pat. No. 6,365,218 (Borschel, et al.) (which is herein incorporated by reference to the extent that it is consistent herewith), U.S. Pat. No. 6,589,576 (Borschel, et al.) (which is herein incorporated by reference to the extent that it is consistent herewith), and U.S. Patent Application No. 20030118703 A1 (Nguyen, et al.) (which is herein incorporated by reference to the extent that it is consistent herewith).

In certain embodiments, the nutritional powder is transferred to a nutritional powder pod. Generally, the transfer can occur by any suitable transfer method. In certain embodiments, after the nutritional powder is added to the nutritional powder pod, the nutritional powder pod is sealed in any suitable manner, including hermetically sealed.

### Nutritional Powder Pods and Packages

Generally, the nutritional powder pod of the present disclosure can be any suitable design for use with a beverage production machine. Certain embodiments of the nutritional power pod comprise at least one chamber and a nutritional powder. In certain embodiments, the nutritional powder pod comprises 1, 2, 3 or 4 chambers, or more.

In some embodiments, the pod may be configured to receive an injector or similar device through which water, air, or other fluids may be introduced to facilitate mixing and reconstitution within the enclosed volume. In some embodiments, the fluid introduced to the pod may be pre-filtered or alternatively pass through a filtration unit disposed within the pod. In some embodiments, an outlet member integrally formed as part of or movably coupled to the pod may be positioned for dispensing from the pod.

In certain embodiments, the contents of the pod (e.g., the nutritional powder) is intended to be processed (e.g., rendered suitable for oral consumption by an individual) within seconds after the hermetic seal of the pod is broken to allow liquid to flow therein, the content to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (e.g., the nutritional powder) may be stored for a short time (typically hours or days) by the consumer prior to reconstituting into a liquid product and the pod may or may not be hermetically sealed at any point.

In certain embodiments, any delay between the time the hermetic seal of the pod is disrupted and the initiation time (as defined below) is no more than about 1 second. In other embodiments, any delay between the time the hermetic seal of the pod is disrupted and the initiation time is no more than about 2 seconds. In other embodiments, any delay between the time the hermetic seal of the pod is disrupted and the initiation time is no more than about 3 seconds. In other embodiments, any delay between the time the hermetic seal of the pod is disrupted and the initiation time is no more than about 4 seconds. In other embodiments, any delay between the time the hermetic seal of the pod is disrupted and the initiation time is no more than 5 seconds. In other embodiments, any delay between the time the hermetic seal of the pod is disrupted and the initiation time is from about 1 second to about 10 seconds. In some embodiments, a delay between the time the hermetic seal of the pod is disrupted and the initiation time is from about 1 second to about 30 seconds.

In certain embodiments, the pod contains an amount of nutritional powder corresponding to a single serving. The amount of nutritional powder corresponding to a single serving may vary, for example, based on the intended consumer (e.g., an infant, a toddler, a child, an adult, a healthy individual, a sick individual). In some instances, more nutritional powder than is needed for a single serving may be included in the pod, such as when an ingredient of the formulation is likely to degrade or otherwise lose effectiveness over time.

In certain embodiments, the pod encloses an amount of a nutritional powder that is suitable for being reconstituted into a single serving of a liquid nutritional product upon combination with a certain volume of liquid. In certain embodiments, the pods contain about 2 grams to about 150 grams of nutritional powder, about 2 grams to about 135 grams, about 2 grams to about 130 grams, about 2 grams to about 125 grams, about 2 grams to about 120 grams, about 2 grams to about 115 grams, about 2 grams to about 110 grams, about 5 to about 135 grams, about 5 to about 130 grams, about 5 to about 125 grams, about 5 to about 120 grams, about 5 grams to about 115 grams, about 10 grams to about 140 grams, about 10 grams to about 135 grams, about 10 grams to about 130 grams, about 10 grams to about 125 grams, about 10 grams to about 120 grams, about 15 grams to about 140 grams, about 15 grams to about 135 grams, about 15 grams to about 130 grams, about 15 grams to about 125 grams, about 20 grams to about 140 grams, about 20 grams to about 135 grams, about 20 grams to about 130 grams, about 25 grams to about 140 grams, about 25 grams to about 135 grams, and about 30 grams to about 140 grams. In certain embodiments, the pods contain about 8 grams, about 10 grams, about 12 grams, about 15 grams, about 20 grams, about 25 grams, about 30 grams, about 35 grams, about 40 grams, about 45 grams, about 50 grams, about 60 grams, about 70 grams, about 80 grams, about 90 grams, about 100 grams, about 105 grams, about 110 grams, about 115 grams, about 120 grams, about 125 grams, about 130 grams, about 135 grams, about 140 grams, about 145 grams, or about 150 grams of nutritional powder.

Non-limiting examples of ways in which the present nutritional powder pods may be utilized include their use in a beverage production machine to produce the following liquid products: a hot beverage; a tepid or cool beverage (e.g., an infant formula, a malted beverage, a fruit or juice beverage, a carbonated beverage, a soft drink, or a milk based beverage); a performance beverage (e.g., a performance ready-to-drink beverage); or a functional beverage (e.g., a slimming beverage, a fat burning beverage, a product for improving mental performance or preventing mental decline, or a skin improving product).

In certain embodiments, the nutritional powder pod is unsealed, sealed, or hermetically sealed. In certain embodiments, the nutritional powder pod is re-sealable and, thus, re-usable.

In certain embodiments, a package (or kit) is provided which comprises one or more (e.g., 1, 2, 3, 4, 5, 6, 7, 8, 9, 10, 12, 15, 20, 25, 30, or 50) nutritional powder pods. The package (or kit) can optionally include a beverage production machine. The package (or kit) can optionally include any item that would be suitable, such as one or more of directions for use (e.g., to make a certain volume or composition of nutritional liquid), nutritional information, implements for resealing or reusing the nutritional powder pod, or directions for obtaining information (e.g., a telephone number or website). In certain embodiments, a package (or kit) is provided which includes multiple nutritional powder pods as otherwise disclosed herein. In other embodiments, the package (or kit) can include one or more nutritional powder pods (as otherwise disclosed herein) and a beverage production machine.

### Methods for Preparing a Nutritional Liquid Using the Nutritional Powder Pod

In certain embodiments, the nutritional powder pods as described herein show good reconstitution of the nutritional powder contained within the pod, within the limitations of time, temperature, and liquid volume imposed by the beverage production machine.

Other embodiments disclosed herein include a method for preparing a liquid product using the nutritional powder pod, comprising adding a liquid (e.g., water or a liquid designed to facilitate reconstitution) to the nutritional powder to form the liquid product.

In some embodiments, adequate delivery of the ingredients in the nutritional powder is provided so that the nutritional powder is reconstituted with a defined amount of liquid. Generally, the liquid is mixed with the nutritional powder of the nutritional powder pod to reconstitute the nutritional powder into a liquid product. In certain embodiments, the liquid is passed into and through the nutritional powder pod, mixing with the nutritional powder to reconstitute it into a liquid product. In certain embodiments, the liquid is passed into the nutritional powder pod, mixing with the nutritional powder to reconstitute it into a liquid product. In certain embodiments, the liquid is injected into the nutritional powder pod, mixing with the nutritional product to reconstitute it into a liquid product.

In certain embodiments, the method for preparing a liquid product from a nutritional powder pod comprises adding a liquid (e.g., water or a liquid designed to facilitate reconstitution) at least once to the nutritional powder pod to create a mixture and then transferring (e.g., by any suitable means such as by gravity, by air pressure, by liquid pressure, or combinations thereof) at least a portion of the mixture to a receptacle (e.g., a cup, a bottle, a sippy cup, a mug, an infant formula bottle); the liquid product is provided after the transferring is complete. In some aspects, adding the liquid and transferring to the receptacle optionally occur in overlapping time periods. In certain embodiments, the liquid is added 1 time, 2 times, 3 times, 4 times, 5 times, at least once, or at least twice to the nutritional powder pod.

### Examples

The examples and methods below should be considered to be exemplary only and not construed to be limiting upon the present disclosure. Other nutritional powders can be designed and made. Other test methods and variations of the provided test methods may be used, in certain embodiments, to measure the same physical properties or characteristics of a nutritional powder. Additional examples of nutritional powders and methods may be found herein.

### Example Nutritional Powders

The following paragraphs describe and demonstrate exemplary embodiments of the nutritional powders described herein. The exemplary embodiments are provided solely for the purpose of illustration and are not to be construed as limitations of the present disclosure, as many variations thereof are possible without departing from the spirit and scope of the present disclosure. The exemplary nutritional powders may be prepared in accordance with the methods described herein.

Example 1A illustrates an exemplary nutritional powder that is formulated as an infant formula. All ingredient amounts are listed as pounds (lb) per 1,000 lb batch of nutritional powder.

TABLE 3

| | Example 1A |
|---|---|
| Ingredients | (Quantity (lb) per 1,000 lb batch) |
| Lactose | 388.31 |
| Non-Fat Dry Milk | 203.16 |
| High Oleic Safflower Oil | 115.89 |
| Soy Oil | 88.04 |
| Coconut Oil | 81.09 |
| Galactooligosaccharides | 66.87 |
| Whey Protein Concentrate | 50.00 |
| Potassium Citrate | 9.16 |
| Lecithin | 5.00 |
| Calcium Carbonate | 4.03 |
| Arachidonic Acid | 3.69 |
| Potassium Chloride | 1.25 |
| Docosahexaenoic Acid | 1.11 |
| Magnesium Chloride | 1.03 |
| Sodium Chloride | 0.59 |
| Choline Chloride | 0.43 |
| Vitamin ADEK | 0.39 |
| Ascorbyl Palmitate | 0.37 |
| Mixed Carotenoid Premix | 0.35 |
| Mixed Tocopherols | 0.16 |
| Ascorbic Acid | 1.27 |
| Riboflavin | 0.003 |
| L-Carnitine | 0.026 |
| Vitamin/Mineral Premix | 1.11 |
| Ferrous Sulfate | 0.45 |
| Nucleotide/Choline Premix | 2.33 |

Example 1B illustrates an exemplary nutritional powder that is formulated as a soy-protein containing infant formula. All ingredient amounts are listed as kilogram (kg) per 1,000 kg batch of nutritional powder.

TABLE 4

| | |
|---|---|
| | Example 1B |
| Ingredient | (Quantity (kg) per 1,000 kg batch) |

| Corn Syrup | 504.1 | |
|---|---|---|
| Soy Protein Isolate (5% DH) | 144.8 | |
| Sunflower Oil | 112.5 | |
| Sucrose | 98.3 | |
| Soy Oil | 83.9 | |
| Coconut Oil | 75.6 | |
| Fructooligosaccharides | 17 | |
| Potassium Citrate | 16.5 | |
| Calcium Phosphate | 16.4 | |
| Sodium Chloride | 3.8 | |
| Arachidonic Acid Oil | 3 | |
| Magnesium Chloride | 2.8 | |
| L-Methionine | 1.7 | |
| Ascorbic Acid | 1.1 | |
| Docosahexaenoic Acid Oil | 1.1 | |
| Lutein | 945.0 | mg |
| Choline Chloride | 507.7 | g |
| Taurine | 457.5 | g |
| Inositol | 353.0 | g |
| Ascorbyl Palmitate | 347.5 | g |
| Ferrous Sulfate | 319.2 | g |
| Mixed Tocopherols | 157.2 | g |
| L-Carnitine | 112.7 | g |
| Niacinamide | 97.9 | g |
| D-Alpha-Tocopheryl Acetate | 78.8 | g |
| Calcium D-Pantothenate | 58.7 | g |
| Zinc | 56.0 | g |
| Iron | 16.9 | g |
| Thiamine | 15.2 | g |
| Vitamin A Palmitate | 14.8 | g |
| Copper | 7.2 | g |
| Riboflavin | 6.7 | g |
| Pyridoxine Hydrochloride | 6.1 | g |
| Folic Acid | 2.1 | g |
| Potassium Iodide | 1.1 | g |
| Phylloquinone | 857.1 | mg |
| Vitamin D3 | 47 | mg |
| Lycopene | 980.0 | mg |
| Biotin | 592.5 | mg |
| Beta-Carotene | 215.6 | mg |
| Selenium | 147.0 | mg |
| Cyanocobalamin | 71.3 | mg |

Example 2 illustrates an exemplary nutritional powder that is formulated as a pediatric formula. All ingredient amounts are listed as kilogram (kg) per 1,000 kg batch of nutritional powder.

TABLE 5

| | Example 2 | |
|---|---|---|
| Ingredients | (Quantity (kg) per 1,000 kg batch) | |
| Maltodextrin | 300.0 | |
| Sucrose | 288.0 | |
| Milk Protein Concentrate (80%) | 121.1 | |
| Soy Oil | 82.0 | |
| High Oleic Sunflower Oil | 69.5 | |
| Whey Protein Concentrate | 27.9 | |
| MCT Oil | 26.7 | |
| Soy Protein Isolate | 24.4 | |
| Fructooligosaccharides | 22.9 | |
| Potassium Citrate | 7.1 | |
| Flavor | 6.7 | |
| Magnesium Phosphate Dibasic | 5.7 | |
| Potassium Chloride | 4.3 | |
| Sodium Chloride | 3.7 | |
| Tricalcium Phosphate | 3.2 | |
| Vitamin/Mineral Premix | 2.5 | |
| Docosahexaenoic Acid | 2.0 | |
| Choline Chloride | 1.7 | |
| Potassium Phosphate Monobasic | 1.5 | |
| Calcium Carbonate | 1.4 | |
| Potassium Phosphate Dibasic | 1.2 | |
| Ascorbic Acid | 871.7 | grams |
| Arachidonic Acid | 645.0 | grams |
| Ascorbyl Palmitate | 502.1 | grams |
| Vitamin ADEK Premix | 176.5 | grams |
| Lactobacillus Acidophilus | 100.0 | grams |
| Tocopherol Antioxidant | 83.7 | grams |
| dl-Alpha Tocopheryl Acetate | 49.5 | grams |
| Bifidobacterium Lactis | 35.0 | grams |
| Vitamin A Palmitate | 1.2 | grams |
| Potassium Iodide | 89.2 | milligrams |

| | |
|---|---|
| Sodium Citrate | As Needed |
| Magnesium Chloride | As Needed |
| Citric Acid (processing aid) | As Needed |
| Potassium Hydroxide (processing aid) | As Needed |

Example 3 illustrates an exemplary nutritional powder that is formulated as an adult nutritional product. All ingredient amounts are listed as kilogram (kg) per 1,000 kg batch of nutritional powder.

TABLE 6

| | Example 3 | |
|---|---|---|
| Ingredients | (Quantity (kg) per 1,000 kg batch) | |
| Maltodextrin | 268.7 | |
| Corn Syrup Solids | 192.7 | |
| Milk Protein Concentrate (80%) | 133 | |
| Sucrose | 112.4 | |
| High Oleic Sunflower Oil | 85.3 | |
| Soy Oil | 38.5 | |
| Soy Protein Isolate | 54.7 | |
| Fructooligosaccharides | 21.9 | |
| Inulin | 21.9 | |
| Canola Oil | 13.8 | |
| Sodium Citrate | 12.8 | |
| Potassium Citrate | 11.7 | |
| Flavor | 7.3 | |
| Magnesium Chloride | 6.3 | |
| Potassium Chloride | 4.2 | |
| Tricalcium Phosphate | 3.5 | |
| Choline Chloride | 1.7 | |
| Ascorbic Acid | 880.0 | grams |
| Calcium Carbonate | 553.0 | grams |
| Water Soluble Vitamin Premix | 485.0 | grams |
| Ultra Trace Mineral/Trace Mineral | 430.0 | grams |
| Ascorbyl Palmitate | 164.6 | grams |
| Vitamin AEDK Premix | 146.7 | grams |
| Tocopherol Antioxidant | 82.3 | grams |
| dl-Alpha Tocopheryl Acetate | 44.7 | grams |
| Beta Carotene (30%) | 5.5 | grams |
| Manganese Sulfate | 3.7 | grams |
| Thiamin Hydrochloride | 2.5 | grams |
| Riboflavin | 1.5 | grams |
| Vitamin A Palmitate | 1.2 | grams |
| Potassium Iodide | 913.3 | milligrams |

| | |
|---|---|
| Magnesium Sulfate | As Needed |
| Copper Sulfate | As Needed |
| Citric Acid (processing aid) | As Needed |
| Potassium Hydroxide (processing aid) | As Needed |

In the Data Sets that follow, Examples 4-38 illustrate the physical properties of various nutritional powders of the present invention. The nutritional powders were prepared according to the methods described previously. The nutritional powders included powders prepared by spray-dried (encoded “SD” in the table), dry blended (encoded “DB” in the table), and extruded (encoded “EX” in the table) manufacturing methods. Examples 4-15, 20, 21, and 32 are formulations that are similar to the formulation provided in Table 3. Examples 16 and 35 are formulations that are similar to the formulation provided in Table 4. Examples 24, 25, and 37 are formulations that are similar to the formulation provided in Table 5. Examples 26, 27, 30, and 38 are formulations that are similar to the formulation provided in Table 6. Examples 8 and 9 are the same product, but are different batches from the same facility. Examples 10 and 11 are the same product, but are different batches from the same facility; Example 14 is the same product as Examples 10 and 11, but was made at a different location. The nutritional powders included infant, toddler, and adult formulations.

### Example Data Set 1

Volume Flowability—Flowability Index

The flowability index is the ratio of vibrated bulk density to the loose bulk density, and is calculated as follows.

$$\frac{[ vibrated bulk density ( g \text{/} cc ) ]}{[ loose bulk density ( g \text{/} cc ) ]} = Flowability ( unitless )$$

The loose bulk density and the vibrated bulk density can be determined using any suitable method. Under certain circumstances, a flowability index greater than about 2 indicates that a nutritional powder may have poor flowability. For the data collected below, the following methods were used.

Loose Bulk Density Test

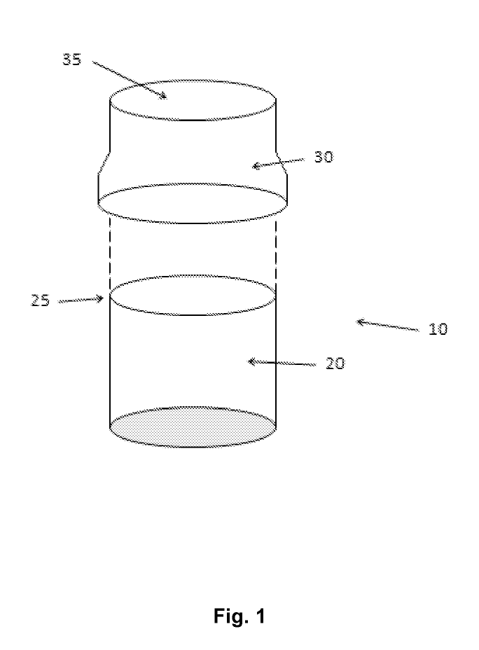

Generally, loose bulk density of a powder can be measured by any of several industry standard methods, including, but not limited to, ASTM D6683-14, “Standard Test Method for Measuring Bulk Density Values of Powders and Other Bulk Solids as a Function of Compressive Stress,” and GEA Niro Analytical Method A 2 A, “Powder Bulk Density.” In the data collected below, the test method that was adapted to measure the loose bulk density of a powder used the same equipment employed in the Vibrated Bulk Density Test below. More specifically, the test method used a test cylinder having a top portion and bottom portion capable of being separated. One exemplary test cylinder was a Plexiglas® bulk density test cylinder 10, illustrated in FIG. 1, which comprised a calibrated bottom portion 20 and a top portion 30. In some instances, the volume of the bottom portion 20 of the test cylinder 10 was calibrated and permanently labeled thereon. The calibration may be in any appropriate volumetric measurement, e.g., cubic centimeters (“cc”) or milliliters (“mL”).

The bottom portion 20 of the test cylinder 10 was weighed to determine the tare weight. The top portion 30 of the test cylinder was then placed on top of the bottom portion 20 of the test cylinder. The test cylinder 10 was then filled to near overflowing with the test powder (e.g., through the opening 35 at the top of the top portion 30). Care was taken to avoid compressing the powder as the cylinder was filled. A powder funnel was used to simplify this task, in some instances. Visible air gaps or unfilled portions of the cylinder were avoided.

Any excess powder was removed and the top of the cylinder was removed. For example, when using the test cylinder 10 illustrated in FIG. 1, the top section 30 of the test cylinder 10 was carefully removed over an appropriate waste receptacle. Using a spatula, the excess powder sample above the mouth 25 of the bottom section 20 of the test cylinder was struck off such that the powder contained in the bottom section 20 was smooth and flush with the mouth 25. Using a dry cloth, any powder clinging to the outside of the bottom section 20 was removed.

The bottom section of the test cylinder with the loose powder sample was then weighed to determine the gross weight. The loose bulk density of the powder was calculated as follows:

$$\frac{[ Gross weight ( g ) ] - [ Tare weight ( g ) ]}{[ Calibrated test cylinder volume ( cc ) ]} = Loose Bulk Density ( g \text{/} cc )$$

Vibrated Bulk Density Test

Generally, the following test method was used to measure the bulk density of a powder that has been compressed by vibration in a reproducible manner. More specifically, the test method used a test cylinder having a top portion and bottom portion capable of being separated. One exemplary test cylinder was a Plexiglas® bulk density test cylinder 10, illustrated in FIG. 1, which comprises a calibrated bottom portion 20 and a top portion 30. In some instances, the volume of the bottom portion 20 of the test cylinder 10 was calibrated and permanently labeled thereon. The calibration may be in any appropriate volumetric measurement, e.g., cubic centimeters (“cc”) or milliliters (“mL”).

The bottom portion 20 of the test cylinder 10 was weighed to determine the tare weight. The top portion 30 of the test cylinder was then placed on top of the bottom portion 20 of the test cylinder. The test cylinder 10 was then filled to near overflowing with the test powder (e.g., through the opening 35 at the top of the top portion 30). Care was taken to avoid compressing the powder as the cylinder is filled. A powder funnel was used to simplify this task, in some instances. Visible air gaps or unfilled portions of the cylinder were avoided.

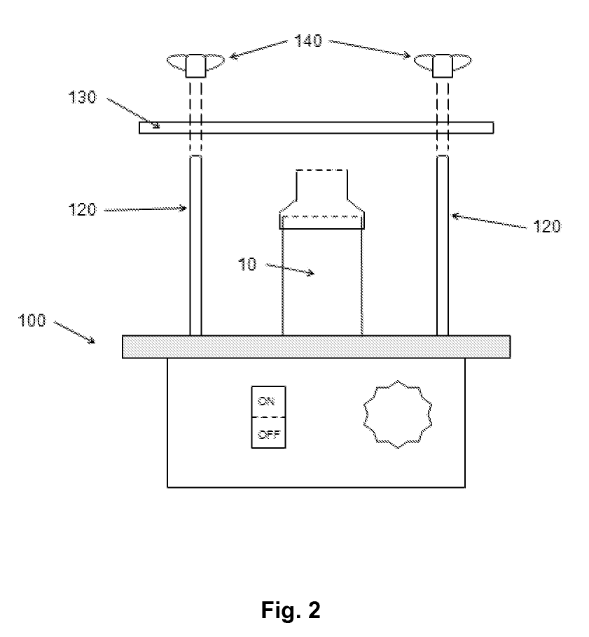

The test cylinder 10 was placed on or in a vibration apparatus (e.g., a modified Syntron® J-1A portable jogger 100, as illustrated in FIG. 2). The test cylinder 10 was secured to the vibration apparatus by being placed between the clamping rods 120 and clamped in place with the clamping strap 130 and wing nuts 140. The modified vibration table 100 was set to a predetermined amplitude (i.e., amplitude=5, frequency=60 Hz), and the test cylinder was vibrated for a 60-second vibration cycle.

When the vibration cycle was complete, the test cylinder was unclamped and removed from the modified vibration table 100. Any excess powder was removed and the top of the cylinder was removed. For example, when using the test cylinder 10 illustrated in FIG. 1, the top section 30 of the test cylinder 10 was carefully removed over an appropriate waste receptacle. Using a spatula, the excess powder sample above the mouth 25 of the bottom section 20 of the test cylinder was struck off such that the powder contained in the bottom section 20 was smooth and flush with the mouth 25. Using a dry cloth, any powder clinging to the outside of the bottom section 20 was removed.

The bottom section of the test cylinder with the vibrated powder sample was then weighed to determine the gross weight. The vibrated bulk density of the powder was calculated as follows:

$$\frac{[ Gross weight ( g ) ] - [ Tare weight ( g ) ]}{[ Calibrated test cylinder volume ( cc ) ]} = Vibrated Bulk Density ( g \text{/} cc )$$

Volume Flowability—Flow Factor

Volume flowability can be determined using any of the test methods suitable for the Brookfield Powder Flow Tester (Brookfield Engineering Laboratories, Inc., Middleboro, Mass.), including those provided in a Brookfield Powder Flow Tester manual such as Manual No. M09-1200-C0213. The Brookfield Powder Flow Tester measures the flow factor of the powder in dimensionless units of “ff”. Flow factor is defined as the ratio of major principal consolidating stress (x-axis) to unconfined failure strength (y-axis) at 10 kPa of x-axis. Flow index is the inverse of flow factor. The flow index ranges from 0 to 1. As the flow index approaches 0, the more free-flowing the sample. As the flow index approaches 1, the more cohesive the sample. For the data collected below, the methods to determine flow factor using a Brookfield Powder Flow Tester are provided in the following paragraph.

About 200 to 250 grams of sample material was needed to run a single test if the standard trough was used and about 34-42 grams were needed to run a single test if the small sample volume trough was used. If repeated tests were performed on the same sample, then twice the amount was used to allow for spillage during sample preparation and testing. The standard trough holds about 230 cc of sample material when the material is level with the top surface of the trough, and the small volume sample trough holds about 38 cc when the material is level with the top surface of the trough. Additional sample was required when the vane lid was used; this additional sample increased the total sample size to about 260-270 cc of material for a standard trough and to about 40-45 cc of material for a small sample volume trough. No additional sample was typically needed when the wall friction lid was used. Prior to testing a sample, the trough was weighed before filling it with sample material. When sufficient sample was placed in the trough, the sample was shaped and evenly distributed to remove excess material. The weight of the sample material in the trough was then determined by subtracting the empty trough weight from the trough with the shaped, evenly distributed sample material (i.e., do not include the weight of the removed excess material). The weight of the sample material in the trough was inputted into the Brookfield Powder Flow Tester software. The test was then initiated and took approximately 20 minutes to run.

Some exemplary nutritional powders were tested to determine the loose bulk density, vibrated bulk density of each, the volume flowability (flowability index), and the volume flowability (flow factor). These results are shown in Table 7.

TABLE 7

| | | Loose | Vibrated | Volume | |
|---|---|---|---|---|---|
| | | Bulk | Bulk | Flowability - | Volume |
| | Sample | Density | Density | Flowability | Flowability - |
| Example | Code | (g/cc) | (g/cc) | Index | Flow Factor |
| Example 4 | SD-1A | 0.46 | 0.57 | 1.2 | 5 |
| Example 5 | SD-2A | 0.43 | 0.56 | 1.3 | 6 |
| Example 6 | SD-7A | 0.42 | 0.54 | 1.3 | 6 |
| Example 7 | SD-8D | 0.42 | 0.55 | 1.3 | 8 |
| Example 8 | SB-1D | 0.50 | 0.62 | 1.2 | 6 |
| Example 9 | SD-2D | 0.50 | 0.63 | 1.3 | 6 |
| Example 10 | SD-3D | 0.49 | 0.63 | 1.3 | 7 |
| Example 11 | SD-4D | 0.52 | 0.62 | 1.2 | 7 |
| Example 12 | SD-8A | 0.41 | 0.46 | 1.1 | 5 |
| Example 13 | SD-9A | 0.42 | 0.56 | 1.3 | 7 |
| Example 14 | SD-1C | 0.48 | 0.58 | 1.2 | 5 |
| Example 15 | SD-2C | 0.47 | 0.58 | 1.2 | 6 |
| Example 16 | SD-3C | 0.48 | 0.61 | 1.3 | 5 |
| Example 17 | SD-3A | 0.46 | 0.57 | 1.2 | 5 |
| Example 18 | SD-4A | 0.42 | 0.54 | 1.3 | 5 |
| Example 19 | SD-6A | 0.43 | 0.56 | 1.3 | 4 |
| Example 20 | DB-1B | 0.48 | 0.63 | 1.3 | 7 |
| Example 21 | DB-2B | 0.44 | 0.59 | 1.3 | 6 |
| Example 22 | DB-5A | 0.44 | 0.55 | 1.2 | 5 |
| Example 23 | DB-4C | 0.45 | 0.55 | 1.2 | 4 |
| Example 24 | DB-7C | 0.51 | 0.67 | 1.3 | 6 |
| Example 25 | DB-5D | 0.40 | 0.57 | 1.4 | 6 |
| Example 26 | DB-8C | 0.54 | 0.66 | 1.2 | 7 |
| Example 27 | DB-6D | 0.48 | 0.61 | 1.3 | 8 |
| Example 28 | DB-5C | 0.42 | 0.52 | 1.3 | 7 |
| Example 29 | DB-6C | 0.42 | 0.60 | 1.4 | 11 |
| Example 30 | DB-7D | 0.52 | 0.65 | 1.3 | 6 |
| Example 31 | DB-9C | 0.60 | 0.74 | 1.2 | 13 |
| Example 32 | EX-3B | 0.55 | 0.65 | 1.2 | 4 |
| Example 33 | EX-4B | 0.40 | 0.51 | 1.3 | 6 |
| Example 34 | EX-5B | 0.28 | 0.35 | 1.3 | 3 |
| Example 35 | EX-6B | 0.41 | 0.52 | 1.3 | 7 |
| Example 36 | EX-7B | 0.42 | 0.54 | 1.3 | 5 |
| Example 37 | EX-8B | 0.39 | 0.52 | 1.3 | 7 |
| Example 38 | EX-9B | 0.60 | 0.73 | 1.2 | 6 |
| Summary | Min | 0.28 | 0.35 | 1.1 | 3 |
| (All) | Avg | 0.46 | 0.58 | 1.3 | 6 |
| | Max | 0.60 | 0.74 | 1.4 | 13 |
| Summary | Min | 0.41 | 0.46 | 1.1 | 4 |
| (SD) | Avg | 0.46 | 0.57 | 1.3 | 6 |
| | Max | 0.52 | 0.63 | 1.3 | 8 |
| Summary | Min | 0.40 | 0.52 | 1.2 | 4 |
| (DB) | Avg | 0.47 | 0.61 | 1.3 | 7 |
| | Max | 0.60 | 0.74 | 1.4 | 13 |
| Summary | Min | 0.28 | 0.35 | 1.2 | 3 |
| (EX) | Avg | 0.43 | 0.54 | 1.3 | 5 |
| | Max | 0.60 | 0.73 | 1.3 | 7 |

### Example Data Set 2

The mean particle size and particle size distribution of the nutritional powders of Examples 4-38 were measured using laser diffraction. Here, the size of the particles of the nutritional powder was evaluated using a laser diffraction particle size analyzer (Sympatec HELOS Model 1005 laser diffraction sensor) with a laser operating at 632.8 nm. The powder was dispersed into an air stream and passed through the laser beam. The particles diffracted the photons of the laser at different angles, depending on the size of the particle. A detector with semicircular ring elements detected the diffracted photons. The intensity of the detected photons and the angle of detection were used to calculate the number, area, and volume-weighted particle size in the sample, and a particle size distribution was determined. From this distribution, an average particle size, based on the number, area, or volume of particles, can also be calculated. For the D10, D50, and D90 particle size distribution, D10 indicates that 10% of particles have a diameter below D10 diameter, D50 indicates that 50% of particles have a diameter below the D50 diameter (this is the median particle size), and D90 indicates that 90% of particles have a diameter below the D90 diameter. The results are provided in Table 8.

TABLE 8

| | | Mean | | | |
|---|---|---|---|---|---|
| | Sample | Particle Size | Particle Size Distribution (μm) | | |
| Example | Code | (μm) | D10 | D50 | D90 |
| Example 4 | SD-1A | 141 | 31 | 124 | 275 |
| Example 5 | SD-2A | 159 | 52 | 146 | 287 |
| Example 6 | SD-7A | 145 | 46 | 135 | 254 |
| Example 7 | SD-8D | 140 | 47 | 129 | 247 |
| Example 8 | SB-1D | 181 | 56 | 166 | 330 |
| Example 9 | SD-2D | 205 | 62 | 184 | 378 |
| Example 10 | SD-3D | 191 | 58 | 171 | 356 |
| Example 11 | SD-4D | 181 | 57 | 161 | 378 |
| Example 12 | SD-8A | 156 | 44 | 118 | 225 |
| Example 13 | SD-9A | 128 | 46 | 144 | 282 |
| Example 14 | SD-1C | 113 | 39 | 103 | 201 |
| Example 15 | SD-2C | 125 | 31 | 115 | 231 |
| Example 16 | SD-3C | 140 | 31 | 125 | 272 |
| Example 17 | SD-3A | 146 | 44 | 128 | 277 |
| Example 18 | SD-4A | 130 | 30 | 115 | 247 |
| Example 19 | SD-6A | 121 | 21 | 106 | 240 |
| Example 20 | DB-1B | 99 | 18 | 87 | 195 |
| Example 21 | DB-2B | 113 | 26 | 100 | 221 |
| Example 22 | DB-5A | 147 | 38 | 127 | 288 |
| Example 23 | DB-4C | 101 | 22 | 85 | 203 |
| Example 24 | DB-7C | 117 | 22 | 99 | 240 |
| Example 25 | DB-5D | 104 | 13 | 84 | 221 |
| Example 26 | DB-8C | 133 | 29 | 122 | 247 |
| Example 27 | DB-6D | 123 | 37 | 104 | 236 |
| Example 28 | DB-5C | 137 | 29 | 124 | 263 |
| Example 29 | DB-6C | 146 | 17 | 139 | 257 |
| Example 30 | DB-7D | 105 | 21 | 89 | 208 |
| Example 31 | DB-9C | 148 | 19 | 128 | 308 |
| Example 32 | EX-3B | 334 | 50 | 338 | 599 |
| Example 33 | EX-4B | 273 | 61 | 238 | 541 |
| Example 34 | EX-5B | 164 | 36 | 129 | 348 |
| Example 35 | EX-6B | 173 | 46 | 148 | 339 |
| Example 36 | EX-7B | 179 | 30 | 142 | 391 |
| Example 37 | EX-8B | 176 | 39 | 141 | 375 |
| Example 38 | EX-9B | 379 | 61 | 330 | 777 |
| Summary | Min | 99 | 13 | 84 | 195 |
| (All) | Avg | 159 | 37 | 141 | 307 |
| | Max | 379 | 62 | 338 | 777 |
| Summary | Min | 113 | 21 | 103 | 201 |
| (SD) | Avg | 150 | 43 | 136 | 280 |
| | Max | 205 | 62 | 184 | 378 |
| Summary | Min | 99 | 13 | 84 | 195 |
| (DB) | Avg | 123 | 24 | 107 | 241 |
| | Max | 148 | 38 | 139 | 308 |
| Summary | Min | 164 | 30 | 129 | 339 |
| (EX) | Avg | 240 | 46 | 209 | 482 |
| | Max | 379 | 61 | 338 | 777 |

### Example Data Set 3

Moisture Content—

Moisture content was determined by weighing a powder sample before and after drying, and then dividing the change in weight upon drying by the weight of the sample prior to drying.

Generally, the temperature used for drying can be any suitable temperature (e.g., 20° C., 30° C., 40° C., 50° C., 60° C., 70° C., 80° C., 90° C., or 100° C.) such as a temperature that does not result in decomposition of the sample and can be adjusted depending on the oven type (e.g., a vacuum oven, a convection oven, or a conventional oven). A sample can be dried for varying periods of time to attempt to remove all moisture from the sample, thereby providing a more accurate measure of moisture content.

For the data below, the sample was heated in an oven at a temperature of 100° C. for 5.5 hours. In some instances, a vacuum oven was used, otherwise a convection oven was used. The sample was then transferred to a desiccator and then weighed soon after reaching room temperature.

Wettability—

The wettability of the nutritional powder was measured indirectly by dropping one level tablespoon (about 2 grams) of powder onto the surface of water in a 100 mL glass beaker, and recording the time it takes for all of the powder to fall below the surface. This method was stopped at 120 seconds after the powder was dropped onto the surface of the water.

Surface Area—

Surface area was measured by the Brunauer-Emmett-Teller (BET) multilayer gas adsorption method using the Micromeritics TriStar II 3020 surface area and porosity analyzer using Krypton option.

Aspect Ratio, Non-Circularity, Circularity, and Convexity—

The aspect ratio, non-circularity <0.95, circularity, and convexity were determined using a Malvern Morphologi G3 particle characterization system to measure and analyze particle dimensions. The powder was dispersed into an air stream and passed through the laser beam. The particles diffracted the photons of the laser at different angles, depending on the size of the particle. A detector with semicircular ring elements detected the diffracted photons. The intensity of the detected photons and the angle of detection were used to calculate the number, area, volume-weighted particle size, and other relevant measures in the sample, and aspect ratio, non-circularity <0.95, circularity, and convexity were determined.

TABLE 9

| | | | | | | Non- | | |
|---|---|---|---|---|---|---|---|---|
| | | Moisture | Wettability | Surface Area | | Circularity | | |
| Example | Sample Code | (g/100 g) | (Sec) | (m²/g) | Aspect Ratio | <0.95 (%) | Circularity | Convexity |
| Example 4 | SD-1A | — | 7 | 0.08 | 0.82 | 70.0 | 0.895 | 0.941 |
| Example 5 | SD-2A | — | 5 | — | — | — | — | — |
| Example 6 | SD-7A | — | 4 | 0.02 | 0.83 | 59.6 | 0.908 | 0.951 |
| Example 7 | SD-8D | — | 4 | 0.06 | 0.82 | 51.0 | 0.930 | 0.973 |
| Example 8 | SD-1D | — | 7 | 0.04 | 0.77 | 62.2 | 0.922 | 0.989 |
| Example 9 | SD-2D | — | 4 | 0.05 | 0.82 | 52.2 | 0.929 | 0.977 |
| Example 10 | SD-3D | — | 11 | — | — | — | — | — |
| Example 11 | SD-4D | — | 7 | — | — | — | — | — |
| Example 12 | SD-8A | — | 5 | — | — | — | — | — |
| Example 13 | SD-9A | — | 4 | — | — | — | — | — |
| Example 14 | SD-1C | — | 70 | 0.06 | 0.87 | 29.9 | 0.954 | 0.985 |
| Example 15 | SD-2C | — | 84 | — | — | — | — | — |
| Example 16 | SD-3C | — | 15 | 0.08 | 0.84 | 61.9 | 0.927 | 0.966 |
| Example 17 | SD-3A | 2.7 | 10 | — | — | — | — | — |
| Example 18 | SD-4A | 2.4 | >120 | — | — | — | — | — |
| Example 19 | SD-6A | — | 8 | 0.10 | 0.81 | 64.1 | 0.920 | 0.967 |
| Example 20 | DB-1B | 1.8 | >120 | 0.05 | 0.77 | 65.9 | 0.907 | 0.967 |
| Example 21 | DB-2B | 1.5 | 92 | — | — | — | — | — |
| Example 22 | DB-5A | — | >120 | 0.11 | 0.80 | 68.5 | 0.897 | 0.947 |
| Example 23 | DB-4C | — | >120 | 0.12 | 0.82 | 62.7 | 0.913 | 0.964 |
| Example 24 | DB-7C | — | >120 | — | — | — | — | — |
| Example 25 | DB-5D | — | >120 | 0.17 | 0.77 | 61.1 | 0.919 | 0.979 |
| Example 26 | DB-8C | — | >120 | 0.09 | 0.82 | 53.8 | 0.929 | 0.974 |
| Example 27 | DB-6D | — | >120 | — | — | — | — | — |
| Example 28 | DB-5C | 2.7 | >120 | — | — | — | — | — |
| Example 29 | DB-6C | — | 2 | — | — | — | — | — |
| Example 30 | DB-7D | — | >120 | — | — | — | — | — |
| Example 31 | DB-9C | 2.7 | >120 | 0.13 | 0.74 | 69.5 | 0.902 | 0.971 |
| Example 32 | EX-3B | — | >120 | 0.05 | 0.79 | 69.8 | 0.915 | 0.963 |
| Example 33 | EX-4B | 2.9 | >120 | — | — | — | — | — |
| Example 34 | EX-5B | 1.9 | >120 | 0.09 | 0.74 | 74.1 | 0.879 | 0.953 |
| Example 35 | EX-6B | — | >120 | 0.06 | 0.74 | 75.2 | 0.885 | 0.948 |
| Example 36 | EX-7B | 2.5 | >120 | — | — | — | — | — |
| Example 37 | EX-8B | — | 6 | — | — | — | — | — |
| Example 38 | EX-9B | — | >120 | — | — | — | — | — |
| Summary | Min | 1.5 | 2 | 0.02 | 0.74 | 29.9 | 0.879 | 0.941 |
| (All) | Avg | 2.3 | >68 | 0.08 | 0.80 | 61.9 | 0.914 | 0.966 |
| | Max | 2.9 | >120 | 0.17 | 0.87 | 75.2 | 0.954 | 0.989 |
| Summary | Min | 2.4 | 4 | 0.02 | 0.77 | 29.9 | 0.895 | 0.941 |
| (SD) | Avg | 2.6 | >23 | 0.06 | 0.82 | 56.4 | 0.923 | 0.969 |
| | Max | 2.7 | >120 | 0.10 | 0.87 | 70.0 | 0.954 | 0.989 |
| Summary | Min | 1.5 | 2 | 0.05 | 0.74 | 53.8 | 0.897 | 0.947 |
| (DB) | Avg | 2.2 | >108 | 0.11 | 0.78 | 63.6 | 0.911 | 0.967 |
| | Max | 2.7 | >120 | 0.17 | 0.82 | 69.5 | 0.929 | 0.979 |
| Summary | Min | 1.9 | 6 | 0.05 | 0.74 | 69.8 | 0.879 | 0.948 |
| (EX) | Avg | 2.4 | >104 | 0.07 | 0.76 | 73.0 | 0.893 | 0.955 |
| | Max | 2.9 | >120 | 0.09 | 0.79 | 75.2 | 0.915 | 0.963 |

In the table above, “−” indicates that the data was not collected. The wettability method was stopped at 120 seconds; if all of the powder did not fall below the surface by 120 seconds, this is indicated with an entry of “>120” in the table above.

### Example Data Set 4

Nutritional Powder Reconstitution Test—

Generally, the nutritional powder reconstitution test was used to evaluate how thoroughly the nutritional powder was reconstituted under the operating conditions of a beverage production machine, and to determine a corresponding rate of reconstitution.

According to this test, multiple same size portions (e.g., triplicate portions of 2-5 g samples) were taken from the same batch of the nutritional powder to be tested. These portions were weighed both before and after drying by conventional drying techniques (e.g., convection or infrared) to determine the initial moisture content of each portion (i.e., the weight lost to drying). The average initial moisture content (by weight) was then determined by averaging the results from the multiple portions.

Preweighed portions of each test sample of the nutritional powder were enclosed in resealable nutritional powder pods for the reconstitution testing. Example amounts of the test samples of the nutritional powder range from 2-150 grams.

The test system was a working beverage production machine or a model system configured to simulate a beverage production machine and operated under specific conditions. The test system was configured to accommodate and operate under the operating conditions of a beverage product machine, as follows. The pressure within the pod, as well as the temperature of the water that contacts the nutritional powder and the amount of water flowing through the pod were controlled and measurable.

For the reconstitution test, the pod containing the test sample of the nutritional powder was inserted into the test system, and the system was set to deliver a certain amount of water (e.g., about 25-500 mL) at a certain temperature (e.g., in the range of 5-50° C.) under a certain pressure (e.g., 0.5-15 bar, or approximately 7-217 psia) into and through the pod. Under this test, the ratio of powder weight (grams) to water weight (grams) (where the density of water is taken to be 1 g/mL) was lower than 1:1 (e.g., 1:1.1, 1:1.2, 1:1.3, 1:2, 1:3, 1:5, etc.). In other words, relatively less powder (in grams) was used as compared to the amount (in grams) of water. A sufficiently large collection bottle was placed under the dispenser of the test system to receive the homogeneous liquid product output. The test system was started, and the homogeneous liquid product was collected in the collection bottle.

Reconstitution Time—

During the nutritional powder reconstitution test, described above, the reconstitution time was determined by measuring the time that elapses from the initiation time until the reconstituted product was observed to be fully delivered to the collection bottle.

Rate of Reconstitution—

The rate of reconstitution was determined using the general test method and system for the Nutritional Powder Reconstitution Test described above, except that the reconstituted liquid product was collected over 5-second intervals in sequentially-numbered collection vessels. The mass of collected powder in the reconstituted liquid product in each collection vessel was measured using any standard drying technique (e.g., forced air oven, infrared heating, microwave drying, etc.) to remove the water from the collected reconstituted liquid product. The rate of reconstitution was then determined by dividing the weight of total reconstituted solids (i.e., the mass of collected powder (milligram)) by the original mass of nutritional powder in the pod (gram) and the collection time interval (seconds) thereby resulting in a “milligram/gram-second” value.

Reconstitution Yield—

The reconstitution yield was determined by measuring the residual powder in the pod after the general test method and system described for the Nutritional Powder Reconstitution Test described above was completed. A known amount of water was dispensed into the pod and mixed with the remaining powder which was emptied into a collection vessel. The total solids of this rinse water was measured using any standard drying technique (e.g., via a forced air oven or microwave drying technique) to remove the water from the product. To determine the powder remaining in the pod, the grams of total solids in the rinse water was divided by the percentage of total solids in the powder. The reconstitution yield was then determined by subtracting the ratio of powder remaining in the pod to powder put in the pod from 1. The reconstituted yield was reported in the units of “milligram/milligram” (mg/mg) or converted to a percentage (e.g., milligram/milligram×100%).

The reconstitution time and reconstitution yield of some of the nutritional powders of Examples 4-38 were measured as described previously. The results are given in Table 10.

TABLE 10

| | Sample | Reconstitution | Reconstitution |
|---|---|---|---|
| Example | Code | time (sec) | Yield (%) |
| Example 4 | SD-1A | 40 | 99.3 |
| Example 5 | SD-2A | 40 | 98.8 |
| Example 6 | SD-7A | 45 | 99.7 |
| Example 7 | SD-8D | 40 | 92.3 |
| Example 8 | SD-1D | 40 | 91.1 |
| Example 9 | SD-2D | 40 | 99.2 |
| Example 10 | SD-3D | 30 | 98.8 |
| Example 11 | SD-4D | 25 | 94.1 |
| Example 12 | SD-8A | 45 | 99.3 |
| Example 13 | SD-9A | 40 | 91.8 |
| Example 14 | SD-1C | 35 | 91.5 |
| Example 15 | SD-2C | 40 | 94.4 |
| Example 16 | SD-3C | 40 | 98.9 |
| Example 17 | SD-3A | 40 | 98.8 |
| Example 18 | SD-4A | 25 | 82.8 |
| Example 19 | SD-6A | 40 | 99.0 |
| Example 20 | DB-1B | 35 | 98.9 |
| Example 21 | DB-2B | 30 | 96.0 |
| Example 22 | DB-5A | 25 | NA |
| Example 23 | DB-4C | NA | NA |
| Example 24 | DB-7C | 25 | 86.3 |
| Example 25 | DB-5D | 25 | 95.8 |
| Example 26 | DB-8C | NA | NA |
| Example 27 | DB-6D | 25 | 95.3 |
| Example 28 | DB-5C | NA | NA |
| Example 29 | DB-6C | NA | NA |
| Example 30 | DB-7D | NA | NA |
| Example 31 | DB-9C | 40 | 98.5 |
| Example 32 | EX-3B | — | — |
| Example 33 | EX-4B | 45 | 99.3 |
| Example 34 | EX-5B | 40 | 98.7 |
| Example 35 | EX-6B | 40 | 98.9 |
| Example 36 | EX-7B | 45 | 99.0 |
| Example 37 | EX-8B | NA | NA |
| Example 38 | EX-9B | NA | NA |
| Summary | Min | 25 | 82.8 |
| (All) | Avg | 36 | 96.0 |
| | Max | 45 | 99.7 |
| Summary | Min | 25 | 82.8 |
| (SD) | Avg | 38 | 95.6 |
| | Max | 45 | 99.7 |
| Summary | Min | 25 | 86.3 |
| (DB) | Avg | 29 | 95.1 |
| | Max | 40 | 98.9 |
| Summary | Min | 40 | 98.7 |
| (EX) | Avg | 43 | 99.0 |
| | Max | 45 | 99.3 |

In the table above, “NA” indicates that the data was not available due to technical difficulties; “−” indicates that the data was not collected.

The rate of reconstitution of some of the nutritional powders of Examples 4-38 were measured as described previously. The results are given in Table 11.

TABLE 11

| | Sample | Rate of Reconstitution (mg/g-sec) | | | | | | | | |
|---|---|---|---|---|---|---|---|---|---|---|
| Example | Code | 0-5 sec | 5-10 sec | 10-15 sec | 15-20 sec | 20-25 sec | 25-30 sec | 30-35 sec | 35-40 sec | 40-45 sec |
| Example 4 | SD-1A | 18.4 | 4.0 | 0.6 | 0.6 | 0.5 | 0.4 | 0.4 | 0.1 | — |
| Example 5 | SD-2A | 16.5 | 4.6 | 1.1 | 1.0 | 1.3 | 1.1 | 0.6 | 0.1 | — |
| Example 6 | SD-7A | 16.6 | 2.9 | 0.7 | 1.0 | 0.9 | 1.0 | 0.9 | 0.3 | 0.1 |
| Example 7 | SD-8D | 19.7 | 4.9 | 1.1 | 0.8 | 1.3 | 1.1 | 0.9 | 0.2 | — |
| Example 8 | SD-1D | 18.1 | 1.8 | 1.3 | 0.8 | 1.0 | 1.1 | 0.8 | 0.3 | — |
| Example 9 | SD-2D | 19.6 | 3.7 | 0.6 | 0.4 | 0.5 | 0.5 | 0.4 | 0.1 | — |
| Example 10 | SD-3D | 17.2 | 5.3 | 3.1 | 1.8 | 1.8 | 0.7 | — | — | — |
| Example 11 | SD-4D | 15.2 | 3.5 | 8.0 | 2.6 | 0.3 | — | — | — | — |
| Example 12 | SD-8A | 17.9 | 3.1 | 0.8 | 1.0 | 0.9 | 0.8 | 0.7 | 0.2 | 0.1 |
| Example 13 | SD-9A | 18.2 | 5.9 | 1.5 | 0.8 | 1.1 | 1.1 | 1.1 | 0.4 | — |
| Example 14 | SD-1C | 16.5 | 5.1 | 3.0 | 3.6 | 1.4 | 0.2 | 0.1 | — | — |
| Example 15 | SD-2C | 18.8 | 5.3 | 1.6 | 0.7 | 1.0 | 1.1 | 0.7 | 0.1 | — |
| Example 16 | SD-3C | 15.5 | 3.6 | 1.3 | 1.2 | 1.4 | 1.3 | 1.1 | 0.3 | — |
| Example 17 | SD-3A | 14.8 | 5.3 | 1.3 | 0.8 | 1.0 | 1.1 | 0.9 | 0.4 | — |
| Example 18 | SD-4A | 8.9 | 3.0 | 9.0 | 1.0 | 0.2 | — | — | — | — |
| Example 19 | SD-6A | 16.8 | 3.2 | 1.5 | 1.2 | 1.2 | 1.4 | 1.1 | 0.4 | — |
| Example 20 | DB-1B | 19.4 | 5.0 | 2.3 | 1.3 | 0.9 | 0.9 | 0.3 | — | — |
| Example 21 | DB-2B | 13.7 | 5.5 | 3.2 | 5.1 | 3.3 | 0.7 | — | — | — |
| Example 22 | DB-5A | 7.0 | 1.3 | 1.7 | 3.7 | 0.2 | | | | |
| Example 24 | DB-7C | 13.6 | 9 | 5.7 | 7.7 | 0.3 | — | — | — | — |
| Example 25 | DB-5D | 16.2 | 14 | 1.8 | 6.4 | 0.3 | — | — | — | — |
| Example 27 | DB-6D | 21.2 | 11 | 1.5 | 8.0 | 1.5 | — | — | — | — |
| Example 31 | DB-9C | 19.3 | 5.5 | 4.4 | 0.6 | 1.7 | 1.7 | 0.9 | 0.1 | — |
| Example 33 | EX-4B | 15.3 | 10.3 | 0.4 | 1.1 | 0.8 | 0.9 | 0.6 | 0.1 | 0.1 |
| Example 34 | EX-5B | 8.6 | 5.1 | 4.6 | 3.2 | 2.0 | 2.2 | 0.6 | 0.1 | — |
| Example 35 | EX-6B | 16.0 | 3.2 | 1.7 | 1.2 | 1.1 | 1.4 | 1.1 | 0.2 | — |
| Example 36 | EX-7B | 12.0 | 7.5 | 3.8 | 0.3 | 0.8 | 1.0 | 1.2 | 0.7 | 0.1 |
| Summary | Min | 7.0 | 1.3 | 0.4 | 0.3 | | | | | |
| (All) | Avg | 16.0 | 5.3 | 2.5 | 2.1 | | | | | |
| | Max | 21.2 | 13.7 | 9.0 | 8.0 | | | | | |
| Summary | Min | 8.9 | 1.8 | 0.6 | 0.4 | | | | | |
| (SD) | Avg | 16.8 | 4.1 | 2.3 | 1.2 | | | | | |
| | Max | 19.7 | 5.9 | 9.0 | 3.6 | | | | | |
| Summary | Min | 7.0 | 1.3 | 1.5 | 0.6 | | | | | |
| (DB) | Avg | 15.8 | 7.3 | 2.9 | 4.7 | | | | | |
| | Max | 21.2 | 13.7 | 5.7 | 8.0 | | | | | |
| Summary | Min | 8.6 | 3.2 | 0.4 | 0.3 | | | | | |
| (EX) | Avg | 13.0 | 6.5 | 2.6 | 1.5 | | | | | |
| | Max | 16.0 | 10.3 | 4.6 | 3.2 | | | | | |

In the table above, “−” indicates that the nutritional powder was completely delivered to the collection bottle before this time interval. After 20 seconds, the reconstitution rate for all tested nutritional powders was typically less than about 2 mg/g-sec. After 20 seconds, the reconstitution rate for the spray dried nutritional powders was typically less than about 2 mg/g-sec. After 20 seconds, the reconstitution rate for the dry blended nutritional powders was typically less than about 3.5 mg/g-sec. After 20 seconds, the reconstitution rate for the extruded nutritional powders was typically less than about 2 mg/g-sec.

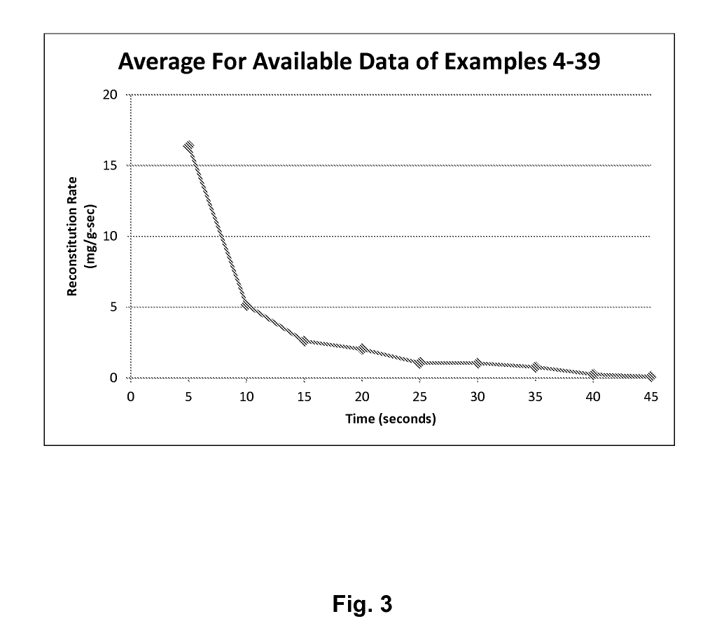

FIG. 3 shows the reconstitution rate as a function of time, averaged for available data of examples 4-38.

### Correlation of Data

The reconstitution time was correlated with the mean particle size (r=0.62), the surface area (r=−0.65), and the flowability index (r=−0.63). The reconstitution yield was correlated with non-circularity <0.95 (r=0.62), circularity (r=−0.61), and convexity (r=−0.71). All correlations were significant with a p-value of less than 0.05 and “r” is the sample Pearson's correlation coefficient.

It was unexpected to find that an increase in flowability index correlates with a decrease in reconstitution time; one would expect that a powder that is less likely to flow (e.g., because the particles hinder each other from flowing) would have more difficulty reconstituting, and hence a longer reconstitution time. It was also unexpected to find that a decrease in mean particle size correlates with a decrease in reconstitution time. As smaller particle sizes would allow less liquid to get into the volume between the particles (at least initially), one would expect more difficulty in dissolving the powder and thus a longer reconstitution time.

The headings used in the disclosure are not meant to suggest that all disclosure relating to the heading is found within the section that starts with that heading. Disclosure for any subject may be found throughout the specification.

It is noted that terms like “preferably,” “commonly,” and “typically” are not used herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Ranges indicated with a dash (XX-YY %) are to be interpreted as inclusive of the end points (i.e., XX and YY) of the range. For example, 5-10% should be interpreted as from 5% to 10%, indicating inclusion of the endpoints, 5% and 10%, in the range. As another example, about 5-10% should be interpreted as from about 5% to about 10%, such that the term “about” modifies both end points, here 5% and 10%.

As used in the disclosure, “a” or “an” means one or more than one, unless otherwise specified. As used in the claims, when used in conjunction with the word “comprising” the words “a” or “an” means one or more than one, unless otherwise specified. As used in the disclosure or claims, “another” means at least a second or more, unless otherwise specified. As used in the disclosure, the phrases “such as”, “for example”, and “e.g.” mean “for example, but not limited to” in that the list following the term (“such as”, “for example”, or “e.g.”) provides some examples but the list is not necessarily a fully inclusive list. The word “comprising” means that the items following the word “comprising” may include additional unrecited elements or steps; that is, “comprising” does not exclude additional unrecited steps or elements.

Detailed descriptions of one or more aspects, instances, or embodiments are provided herein. It is to be understood, however, that the present invention may be embodied in various forms. Therefore, specific details disclosed herein (even if designated as preferred or advantageous) are not to be interpreted as limiting, but rather are to be used as an illustrative basis for the claims and as a representative basis for teaching one skilled in the art to employ the present invention in any appropriate manner. Indeed, various modifications of the invention in addition to those described herein will become apparent to those skilled in the art from the foregoing description and any accompanying figures. Such modifications are intended to fall within the scope of the claims.

1. A nutritional powder pod for use with a beverage production machine, the nutritional powder pod comprising a pod containing a nutritional powder, wherein the nutritional powder comprises particles and the nutritional powder has a volume flowability index of from about 1 to about 2 and a reconstitution time of no more than about 60 seconds.

2.-3. (canceled)

4. The nutritional powder pod of claim 1, wherein the nutritional power has a reconstitution yield of at least about 75%.

5.-7. (canceled)

8. The nutritional powder pod of claim 1, wherein the nutritional powder is an infant formula and the nutritional powder has a fat content of from about 10% wt/wt to about 40% wt/wt.

9. The nutritional powder pod of claim 1, wherein the nutritional powder has a rate of reconstitution of no more than about 25 mg/g-sec.

10. (canceled)

11. The nutritional powder pod of claim 1, wherein the amount of nutritional powder in the pod is from about 2 grams to about 150 grams.

12. The nutritional powder pod of claim 1, wherein the nutritional powder further comprises a caking agent, a flowing agent, or both.

13. (canceled)

14. The nutritional powder pod of claim 1, wherein at least a portion of the nutritional powder is an extruded powder, a dry-blended powder, or a spray-dried powder.

15. The nutritional powder pod of claim 1, wherein at least a portion of the nutritional powder is an agglomerated powder.

16. The nutritional powder pod of claim 1, wherein the nutritional powder is an infant formula, a pediatric formula, or an adult formula.

17.-18. (canceled)

19. The nutritional powder pod of claim 1, wherein the nutritional powder particles have a surface area of from 0.01 m²/g to about 0.5 m²/g.

20. The nutritional powder pod of claim 1, wherein the nutritional powder particles have a non-circularity of from about 20% to about 90% or from about 25% to about 80%.

21. The nutritional powder pod of claim 1, wherein the nutritional powder particles have a circularity of from about 0.85 to about 0.99.

22. The nutritional powder pod of claim 1, wherein the nutritional powder particles have a convexity of from about 0.9 to about 0.995.

23. (canceled)

24. A method for preparing a liquid product using the nutritional powder pod of claim 1, comprising mixing a liquid, such as water, with nutritional powder from the nutritional powder pod, to provide the liquid product, wherein the liquid product comprises at least about 75% wt of the nutritional powder.

25. (canceled)

26. The method of claim 24, wherein the liquid product has a temperature from about 5° C. to about 50° C.

27.-28. (canceled)

29. A method for preparing a nutritional powder pod for use in a beverage production machine, comprising enclosing a nutritional powder in a pod, thereby resulting in the nutritional powder pod,
wherein the nutritional powder has a volume flowability index of from about 1 to about 2 and a reconstitution time of no more than about 60 seconds.

30.-36. (canceled)

37. The method of claim 29, wherein the nutritional powder is an infant formula and has a fat content of from about 10% wt/wt to about 40% wt/wt.

38. A nutritional powder pod produced by the method of claim 29.

39. A package comprising a plurality of nutritional powder pods according to claim 1.

40. A kit comprising one or more nutritional powder pods according to claim 1 and a beverage production machine.
